(19) United States
(12) Patent Application Publication
(10) Pub. No.: US 2025/0070943 A1
(43) Pub. Date: Feb. 27, 2025

(54) UNLICENSED SIDELINK POSITIONING REFERENCE SIGNAL TRANSMISSION AND RESOURCE ALLOCATION

(71) Applicant: Lenovo (Singapore) Pte. Limited, Singapore (SG)

(72) Inventors: Robin Rajan Thomas, Frankfurt (DE); Karthikeyan Ganesan, Kronberg Im Taunus (DE); Alexander Golitschek Edler von Elbwart, Darmstadt (DE)

(73) Assignee: Lenovo (Singapore) Pte. Limited, Singapore (SG)

(21) Appl. No.: 18/810,095

(22) Filed: Aug. 20, 2024

Related U.S. Application Data
(60) Provisional application No. 63/520,804, filed on Aug. 21, 2023.

(51) Int. Cl. H04L 5/00; H04W 72/40

(52) U.S. Cl. CPC H04L 5/0051; H04W 72/40

(57) ABSTRACT

Various aspects of the present disclosure relate to unlicensed sidelink positioning reference signal transmission and resource allocation. An apparatus, such as a UE or other communication device, receives a resource allocation configuration to perform sidelink positioning reference signal (SL-PRS) transmission over unlicensed carriers. The resource allocation configuration can include at least resource block (RB) sets, subchannel sizes, subchannel numbers, and comb-sizes of multiple SL-PRSs. The UE transmits at least one SL-PRS over an unlicensed carrier based at least in part on the resource allocation configuration.

### RELATED APPLICATION

This application claims priority to U.S. Provisional Application Ser. No. 63/520,804 filed Aug. 21, 2023 entitled “Unlicensed Sidelink Positioning Reference Signal Transmission and Resource Allocation,” the disclosure of which is incorporated by reference herein in its entirety.

### TECHNICAL FIELD

The present disclosure relates to wireless communications, and more specifically to sidelink positioning.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

A wireless communications system can include techniques for determining device position, such as a location of a UE. The current techniques specify and support sidelink positioning reference signal (SL-PRS) transmissions in licensed and intelligent transportation systems (ITS) spectrum bands. However, current device positioning techniques, such as for sidelink positioning, can have limited bandwidth availability, resulting in a slow response and/or inaccurate indications of device location.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include a UE for wireless communication. The UE receives a resource allocation configuration to perform SL-PRS transmission over unlicensed carriers, where the resource allocation configuration includes at least resource block (RB) sets, subchannel sizes, subchannel numbers, and comb-sizes of multiple SL-PRSs. The UE transmits at least one SL-PRS over an unlicensed carrier based at least in part on the resource allocation configuration.

In some implementations of the method and apparatuses described herein, the UE transmits the at least one SL-PRS over one or more unlicensed carriers to multiple communication devices based at least in part on the resource allocation configuration. The UE transmits multiple SL-PRSs over one or more unlicensed carriers to multiple communication devices based at least in part on the resource allocation configuration. The UE transmits a resource allocation configuration request, and in response, receives the resource allocation configuration. The resource allocation configuration is pre-configured by at least one of the UE or a communication device. The UE is at least one of a target UE, an anchor UE with or without a known location, a server UE, a client UE, or a roadside unit. The UE transmits the at least one SL-PRS over the unlicensed carrier to a communication device, the communication device being at least one of a base station, a location server, a target UE, an anchor UE with or without a known location, a server UE, a client UE, or a roadside-unit. The resource allocation configuration indicates a shared resource pool structure with at least one of RB sets defined for SL-PRS and associated sidelink control information, or the RB sets defined for sidelink data and the associated sidelink control information. The resource allocation configuration indicates a shared resource pool structure with RB sets defined for SL-PRS, sidelink data, and associated sidelink control information. The resource allocation configuration indicates a dedicated resource pool structure with RB sets defined for SL-PRS and associated sidelink control information. The resource allocation configuration comprises at least one of a sidelink bandwidth part (BWP), a sidelink positioning resource pool defined in terms of the RB sets, a SL-PRS bandwidth indication, or an indication of contiguous physical resource block (PRB) resource allocation or interlaced PRS resource allocation. A sidelink positioning RB set configuration comprises at least one of multiple SL-PRS resource identifiers (IDs), SL-PRS resource set IDs, SL-PRS transmission-reception point IDs, SL-PRS comb offsets and associated SL-PRS comb sizes, SL-PRS starting symbols and a number of SL-PRS symbols, a number of subchannels, or a channel size. A sidelink positioning RB set configuration comprises multiple interlaced transmissions for SL-PRS RB sets with a number of interlaces that are equally spaced according to a parameter that indicates the number of interlaces or RBs between each of the multiple interlaced RB transmissions. The sidelink positioning RB set configuration is associated with different sidelink positioning transmitters differentiated by IDs comprising at least one of a source-ID, a session-ID, a destination-ID, a unique layer-1 ID, or a unique layer-2 ID. Signaling for the resource allocation configuration includes at least one of a lower-layer UE-specific signaling, a higher-layer UE-specific signaling, or broadcast signaling. Intra-cell guard bands are configured for sidelink data or the SL-PRS transmission. At least one of a transmit frequency hopping for SL-PRS or a receive frequency hopping for SL-PRS is enabled across the RB sets based at least in part on a received frequency hopping configuration comprising one or more sidelink positioning measurements corresponding to at least one of one or more hops, a time between the one or more hops, a same numerology and bandwidth among the one or more hops, a different numerology and bandwidth among the one or more hops, or a switching time between the one or more hops.

Some implementations of the method and apparatuses described herein may further include a processor for wireless communication. The processor receives a resource allocation configuration to perform SL-PRS transmission over unlicensed carriers, the resource allocation configuration including at least RB sets, subchannel sizes, subchannel numbers, and comb-sizes of multiple SL-PRSs. The processor transmits at least one SL-PRS over an unlicensed carrier based at least in part on the resource allocation configuration.

In some implementations of the method and apparatuses described herein, the processor transmits the at least one SL-PRS over one or more unlicensed carriers to multiple communication devices based at least in part on the resource allocation configuration. The processor transmits multiple SL-PRSs over one or more unlicensed carriers to multiple communication devices based at least in part on the resource allocation configuration. The processor transmits a resource allocation configuration request, and in response, receives the resource allocation configuration. The resource allocation configuration is pre-configured by at least one of a UE or a communication device. The UE is at least one of a target UE, an anchor UE with or without a known location, a server UE, a client UE, or a roadside unit. The processor transmits the at least one SL-PRS over the unlicensed carrier to a communication device, the communication device being at least one of a base station, a location server, a target UE, an anchor UE with or without a known location, a server UE, a client UE, or a roadside-unit. The resource allocation configuration indicates a shared resource pool structure with at least one of RB sets defined for SL-PRS and associated sidelink control information, or the RB sets defined for sidelink data and the associated sidelink control information. The resource allocation configuration indicates a shared resource pool structure with RB sets defined for SL-PRS, sidelink data, and associated sidelink control information. The resource allocation configuration indicates a dedicated resource pool structure with RB sets defined for SL-PRS and associated sidelink control information. The resource allocation configuration comprises at least one of a sidelink BWP, a sidelink positioning resource pool defined in terms of the RB sets, a SL-PRS bandwidth indication, or an indication of contiguous PRB resource allocation or interlaced PRS resource allocation. A sidelink positioning RB set configuration comprises at least one of multiple SL-PRS resource IDs, SL-PRS resource set IDs, SL-PRS transmission-reception point IDs, SL-PRS comb offsets and associated SL-PRS comb sizes, SL-PRS starting symbols and a number of SL-PRS symbols, a number of subchannels, or a channel size. A sidelink positioning RB set configuration comprises multiple interlaced transmissions for SL-PRS RB sets with a number of interlaces that are equally spaced according to a parameter that indicates the number of interlaces or RBs between each of the multiple interlaced RB transmissions. The sidelink positioning RB set configuration is associated with different sidelink positioning transmitters differentiated by IDs comprising at least one of a source-ID, a session-ID, a destination-ID, a unique layer-1 ID, or a unique layer-2 ID. Signaling for the resource allocation configuration includes at least one of a lower-layer UE-specific signaling, a higher-layer UE-specific signaling, or broadcast signaling. Intra-cell guard bands are configured for sidelink data or the SL-PRS transmission. At least one of a transmit frequency hopping for SL-PRS or a receive frequency hopping for SL-PRS is enabled across the RB sets based at least in part on a received frequency hopping configuration comprising one or more sidelink positioning measurements corresponding to at least one of one or more hops, a time between the one or more hops, a same numerology and bandwidth among the one or more hops, a different numerology and bandwidth among the one or more hops, or a switching time between the one or more hops.

Some implementations of the method and apparatuses described herein may further include a method performed by a UE, the method including: receiving a resource allocation configuration to perform SL-PRS transmission over unlicensed carriers, the resource allocation configuration comprising at least RB sets, subchannel sizes, subchannel numbers, and comb-sizes of multiple SL-PRSs; and transmitting at least one SL-PRS over an unlicensed carrier based at least in part on the resource allocation configuration.

In some implementations of the method and apparatuses described herein, the method further comprising transmitting the at least one SL-PRS over one or more unlicensed carriers to multiple communication devices based at least in part on the resource allocation configuration. The method further comprising transmitting multiple SL-PRSs over one or more unlicensed carriers to multiple communication devices based at least in part on the resource allocation configuration. The method further comprising transmitting a resource allocation configuration request, and in response, receiving the resource allocation configuration. The resource allocation configuration is pre-configured by at least one of the UE or a communication device. The UE is at least one of a target UE, an anchor UE with or without a known location, a server UE, a client UE, or a roadside unit. The method further comprising transmitting the at least one SL-PRS over the unlicensed carrier to a communication device, the communication device being at least one of a base station, a location server, a target UE, an anchor UE with or without a known location, a server UE, a client UE, or a roadside-unit. The resource allocation configuration indicates a shared resource pool structure with at least one of RB sets defined for SL-PRS and associated sidelink control information, or the RB sets defined for sidelink data and the associated sidelink control information. The resource allocation configuration indicates a shared resource pool structure with RB sets defined for SL-PRS, sidelink data, and associated sidelink control information. The resource allocation configuration indicates a dedicated resource pool structure with RB sets defined for SL-PRS and associated sidelink control information. The resource allocation configuration comprises at least one of a sidelink BWP, a sidelink positioning resource pool defined in terms of the RB sets, a SL-PRS bandwidth indication, or an indication of contiguous PRB resource allocation or interlaced PRS resource allocation. A sidelink positioning RB set configuration comprises at least one of multiple SL-PRS resource IDs, SL-PRS resource set IDs, SL-PRS transmission-reception point IDs, SL-PRS comb offsets and associated SL-PRS comb sizes, SL-PRS starting symbols and a number of SL-PRS symbols, a number of subchannels, or a channel size. A sidelink positioning RB set configuration comprises multiple interlaced transmissions for SL-PRS RB sets with a number of interlaces that are equally spaced according to a parameter that indicates the number of interlaces or RBs between each of the multiple interlaced RB transmissions. The sidelink positioning RB set configuration is associated with different sidelink positioning transmitters differentiated by IDs comprising at least one of a source-ID, a session-ID, a destination-ID, a unique layer-1 ID, or a unique layer-2 ID. Signaling for the resource allocation configuration includes at least one of a lower-layer UE-specific signaling, a higher-layer UE-specific signaling, or broadcast signaling. Intra-cell guard bands are configured for sidelink data or the SL-PRS transmission. At least one of a transmit frequency hopping for SL-PRS or a receive frequency hopping for SL-PRS is enabled across the RB sets based at least in part on a received frequency hopping configuration comprising one or more sidelink positioning measurements corresponding to at least one of one or more hops, a time between the one or more hops, a same numerology and bandwidth among the one or more hops, a different numerology and bandwidth among the one or more hops, or a switching time between the one or more hops.

Some implementations of the method and apparatuses described herein may further include a first communication device for wireless communication. The first communication device receives, from a second communication device, a resource allocation configuration to perform SL-PRS transmission over unlicensed carriers, the resource allocation configuration including at least resource block sets, subchannel sizes, subchannel numbers, and comb-sizes of multiple SL-PRSs. The first communication device transmits at least one SL-PRS to the second communication device over an unlicensed carrier based at least in part on the resource allocation configuration.

In some implementations of the method and apparatuses described herein, the first communication device transmits the at least one SL-PRS over one or more unlicensed carriers to multiple communication devices based at least in part on the resource allocation configuration. The first communication device transmits multiple SL-PRSs over one or more unlicensed carriers to multiple communication devices based at least in part on the resource allocation configuration. The first communication device transmits a resource allocation configuration request, and in response, receives the resource allocation configuration. The resource allocation configuration is pre-configured by at least one of the first communication device or the second communication device. The first communication device is at least one of a target UE, an anchor UE with or without a known location, a server UE, a client UE, or a roadside unit. The second communication device is at least one of a base station, a location server, a target UE, an anchor UE with or without a known location, a server UE, a client UE, or a roadside-unit. The resource allocation configuration indicates a shared resource pool structure with at least one of RB sets defined for SL-PRS and associated sidelink control information, or the RB sets defined for sidelink data and the associated sidelink control information. The resource allocation configuration indicates a shared resource pool structure with RB sets defined for SL-PRS, sidelink data, and associated sidelink control information. The resource allocation configuration indicates a dedicated resource pool structure with RB sets defined for SL-PRS and associated sidelink control information. The resource allocation configuration comprises at least one of a sidelink BWP, a sidelink positioning resource pool defined in terms of the RB sets, a SL-PRS bandwidth indication, or an indication of contiguous PRB resource allocation or interlaced PRS resource allocation. A sidelink positioning RB set configuration comprises at least one of multiple SL-PRS resource IDs, SL-PRS resource set IDs, SL-PRS transmission-reception point IDs, SL-PRS comb offsets and associated SL-PRS comb sizes, SL-PRS starting symbols and a number of SL-PRS symbols, a number of subchannels, or a channel size. A sidelink positioning RB set configuration comprises multiple interlaced transmissions for SL-PRS RB sets with a number of interlaces that are equally spaced according to a parameter that indicates the number of interlaces or RBs between each of the multiple interlaced RB transmissions. The sidelink positioning RB set configuration is associated with different sidelink positioning transmitters differentiated by IDs comprising at least one of a source-ID, a session-ID, a destination-ID, a unique layer-1 ID, or a unique layer-2 ID. Signaling for the resource allocation configuration includes at least one of a lower-layer UE-specific signaling, a higher-layer UE-specific signaling, or broadcast signaling. Intra-cell guard bands are configured for sidelink data or the SL-PRS transmission. At least one of a transmit frequency hopping for SL-PRS or a receive frequency hopping for SL-PRS is enabled across the RB sets based at least in part on a received frequency hopping configuration comprising one or more sidelink positioning measurements corresponding to at least one of one or more hops, a time between the one or more hops, a same numerology and bandwidth among the one or more hops, a different numerology and bandwidth among the one or more hops, or a switching time between the one or more hops.

Some implementations of the method and apparatuses described herein may further include a method performed by a first communication device, the method including: receiving, from a second communication device, a resource allocation configuration to perform SL-PRS transmission over unlicensed carriers, the resource allocation configuration comprising at least resource block sets, subchannel sizes, subchannel numbers, and comb-sizes of multiple SL-PRSs; and transmitting at least one SL-PRS to the second communication device over unlicensed carriers based at least in part on the resource allocation configuration.

In some implementations of the method and apparatuses described herein, the method further comprising transmitting the at least one SL-PRS over one or more unlicensed carriers to multiple communication devices based at least in part on the resource allocation configuration. The method further comprising transmitting multiple SL-PRSs over one or more unlicensed carriers to multiple communication devices based at least in part on the resource allocation configuration. The method further comprising transmitting a resource allocation configuration request, and in response, receiving the resource allocation configuration. The resource allocation configuration is pre-configured by at least one of the first communication device or the second communication device. The first communication device is at least one of a target UE, an anchor UE with or without a known location, a server UE, a client UE, or a roadside unit. The second communication device is at least one of a base station, a location server, a target UE, an anchor UE with or without a known location, a server UE, a client UE, or a roadside-unit. The resource allocation configuration indicates a shared resource pool structure with at least one of RB sets defined for SL-PRS and associated sidelink control information, or the RB sets defined for sidelink data and the associated sidelink control information. The resource allocation configuration indicates a shared resource pool structure with RB sets defined for SL-PRS, sidelink data, and associated sidelink control information. The resource allocation configuration indicates a dedicated resource pool structure with RB sets defined for SL-PRS and associated sidelink control information. The resource allocation configuration comprises at least one of a sidelink BWP, a sidelink positioning resource pool defined in terms of the RB sets, a SL-PRS bandwidth indication, or an indication of contiguous PRB resource allocation or interlaced PRS resource allocation. A sidelink positioning RB set configuration comprises at least one of multiple SL-PRS resource IDs, SL-PRS resource set IDs, SL-PRS transmission-reception point IDs, SL-PRS comb offsets and associated SL-PRS comb sizes, SL-PRS starting symbols and a number of SL-PRS symbols, a number of subchannels, or a channel size. A sidelink positioning RB set configuration comprises multiple interlaced transmissions for SL-PRS RB sets with a number of interlaces that are equally spaced according to a parameter that indicates the number of interlaces or RBs between each of the multiple interlaced RB transmissions. The sidelink positioning RB set configuration is associated with different sidelink positioning transmitters differentiated by IDs comprising at least one of a source-ID, a session-ID, a destination-ID, a unique layer-1 ID, or a unique layer-2 ID. Signaling for the resource allocation configuration includes at least one of a lower-layer UE-specific signaling, a higher-layer UE-specific signaling, or broadcast signaling. Intra-cell guard bands are configured for sidelink data or the SL-PRS transmission. At least one of a transmit frequency hopping for SL-PRS or a receive frequency hopping for SL-PRS is enabled across the RB sets based at least in part on a received frequency hopping configuration comprising one or more sidelink positioning measurements corresponding to at least one of one or more hops, a time between the one or more hops, a same numerology and bandwidth among the one or more hops, a different numerology and bandwidth among the one or more hops, or a switching time between the one or more hops.

### BRIEF DESCRIPTION OF THE DRAWINGS

FIG. 1 illustrates an example of a wireless communications system in accordance with aspects of the present disclosure.

FIG. 2 illustrates an example of a system for NR beam-based positioning, in accordance with aspects of the present disclosure.

FIG. 3 illustrates an example of absolute and relative positioning scenarios, in accordance with aspects of the present disclosure.

FIG. 4 illustrates an example of a multi-cell round trip time (RTT) procedure, in accordance with aspects of the present disclosure.

FIG. 5 illustrates an example of a system for relative range estimation using a gNB RTT positioning framework, in accordance with aspects of the present disclosure.

FIG. 6 illustrates an example of various NR-U deployment scenarios, in accordance with aspects of the present disclosure.

FIG. 7 illustrates an example of a first SL-U SL-PRS physical resource allocation structure (PRAS), in accordance with aspects of the present disclosure.

FIG. 8 illustrates an example of a second SL-U SL-PRS PRAS, in accordance with aspects of the present disclosure.

FIG. 9 illustrates an example of a third SL-U SL-PRS PRAS, in accordance with aspects of the present disclosure.

FIG. 10 illustrates an example of an SL-U interlaced SL-PRS configuration for multiplexing different SL-PRS transmissions, in accordance with aspects of the present disclosure.

FIG. 11 illustrates an example of transmit (Tx) and/or receive (Rx) frequency hopping of SL-PRS using the interlace structure, in accordance with aspects of the present disclosure.

FIG. 12 illustrates an example of a UE in accordance with aspects of the present disclosure.

FIG. 13 illustrates an example of a processor in accordance with aspects of the present disclosure.

FIG. 14 illustrates an example of a communication device in accordance with aspects of the present disclosure.

FIG. 15 illustrates a flowchart of a method performed by a UE in accordance with aspects of the present disclosure.

FIG. 16 illustrates a flowchart of a method performed by a communication device in accordance with aspects of the present disclosure.

### DETAILED DESCRIPTION

A wireless communications system enables a sidelink positioning framework for UE-assisted and UE-based positioning methods. The sidelink positioning framework supports varying target positioning requirements across different use cases, such as for vehicle-to-everything (V2X), public safety, industrial Internet of things (IIoT), commercial use cases, and other applications. The sidelink positioning is implemented to determine the absolute or relative position of a UE by utilizing sidelink positioning methods, such as sidelink RTT-type methods, including single-sided and double-sided RTT, SL-angle of arrival (AOA), and SL-time difference of arrival (TDOA). The positioning is based on a new SL-PRS that is transmitted over the PC5 interface and supported in all coverage scenarios, such as in-coverage, partial coverage, and out-of-coverage scenarios, and for PC5-only-based and joint PC5-Uu-based operation scenarios. A new protocol denoted as sidelink positioning protocol (SLPP) is introduced for exchanging the sidelink positioning related information between UEs over the PC5 interface.

Conventional techniques for sidelink positioning specify and support SL-PRS transmissions in licensed and ITS spectrum bands. In the context of sidelink positioning, a variety of sidelink positioning techniques can be utilized to obtain accurate sidelink positioning performance (e.g., suitable accuracy and/or low latency positioning) depending on the scenarios (e.g., bandwidth and channel environment and thus enable the computation of absolute, relative, distance, direction, and position estimates amongst UEs). However, the current sidelink positioning techniques can have limited bandwidth availability, resulting in a slow response and/or inaccurate indications of device location. Further, there are currently no mechanisms to transmit SL-PRS and sidelink positioning-related data over unlicensed bands, or to allocate sidelink positioning resources based on the minimum occupied channel bandwidth and power spectral density (PSD) requirements.

The operation of sidelink data communications over unlicensed spectrum can be supported with the introduction of RB-sets as part of the SL-U transmission and reception, and resource allocation procedures. The utilization of unlicensed spectrum for mobile technologies can be used to enhance cellular services and alleviate the burden of excessive data traffic on mobile networks. Features such as licensed assisted access (LAA) and New Radio unlicensed (NR-U) are 3GPP features that enable the use of unlicensed spectrum. In terms of improved positioning performance, operating in unlicensed bands provides flexibility in terms aggregating and utilizing larger bandwidths. The sidelink positioning operations over the unlicensed bands are designed to leverage the additional bandwidths and transmission for enhanced accuracy and additional degrees of freedom. A key aspect in enabling sidelink positioning over unlicensed bands is the design of the physical resource allocation structures, which are designed to meet regulatory standards consisting of occupied channel bandwidth and PSD requirements, and this disclosure describes aspects to address various SL-U sidelink positioning resource allocation techniques.

The use of unlicensed spectrum can offer positioning performance benefits in terms of positioning accuracy, especially in the case of timing-based positioning techniques (e.g., SL-TDOA). Aspects of the disclosure provide for enhancing the SL-PRS transmission via enhanced resource allocation schemes for SL-U operation. Aspects of the disclosure are directed to the allocation of time-frequency resources of SL-PRS in terms of RB-sets and subchannels within a slot. Different configurations of physical resource allocation structures are described, which involve the use of the positioning dedicated resource pool for SL-PRS only transmission, and a common or shared resource pool for SL-PRS and SL data transmissions. Another aspect of the disclosure is directed to interlacing of different sidelink positioning transmitters, to meet the minimum occupied channel bandwidth requirements within an RB-set. Another aspect of the disclosure involves the Tx and/or Rx frequency hopping of SL-PRS across different RB-sets based on the interlace resource allocation structure.

The described techniques take into account and/or address implementation features, such as to ensure that the minimum scheduling for SL-U supports SL-PRS transmission for a given configuration without degrading positioning accuracy while maintaining power spectral density regulatory requirements and minimum channel occupancy requirements. The implementation features also support different RB-set (resource block sets) schemes that are compatible with the dedicated resource pool and shared resource pools. Additional implementation features include SL-PRS (pre-)configurations for interlace RB-based transmission for dedicated resource pools from the transmitter perspective, as well as to support various (M, N) comb patterns for a minimum listen-before-talk (LBT) bandwidth of 20 MHz, with consideration of full staggering and partial staggering designs, where M is the number of symbols in the time domain and N is the comb size in the frequency domain. The interlace RB-based configuration content includes time indications, frequency domain, and ID indications. Additional implementation features include support for Tx and/or Rx frequency hopping of SL-PRS across multiple RB-sets for enhanced positioning accuracy.

Aspects of the disclosure are directed to solutions and implementations for SL-U positioning, while maintaining the minimum channel occupancy and PSD requirements. In aspects of unlicensed sidelink positioning reference signal transmission and resource allocation, this disclosure details solutions that include support for multiple SL-U SL-PRS physical resource allocation structures, including a first configuration of a common or shared resource pool structure enabling RB-sets defined for SL-PRS transmissions, and for sidelink data (physical sidelink shared channel (PSSCH)) transmissions. The physical resource allocation structures include a second configuration of a common or shared resource pool structure enabling RB-sets, which include SL-PRS transmissions and SL data (PSSCH) transmissions, and include a third configuration of a dedicated resource pool structure enabling RB-sets, which include only SL-PRS transmissions. This disclosure also details solutions that include support to define configurations for interlaced SL-PRS transmission from multiple transmitting UEs, support for SL-PRS Tx and/or Rx frequency hopping across RB-sets based on the interlaces in each RB-set, and support to enable collection of sidelink assistance data error for computing a sidelink positioning integrity result.

Aspects of the present disclosure are described in the context of a wireless communications system.

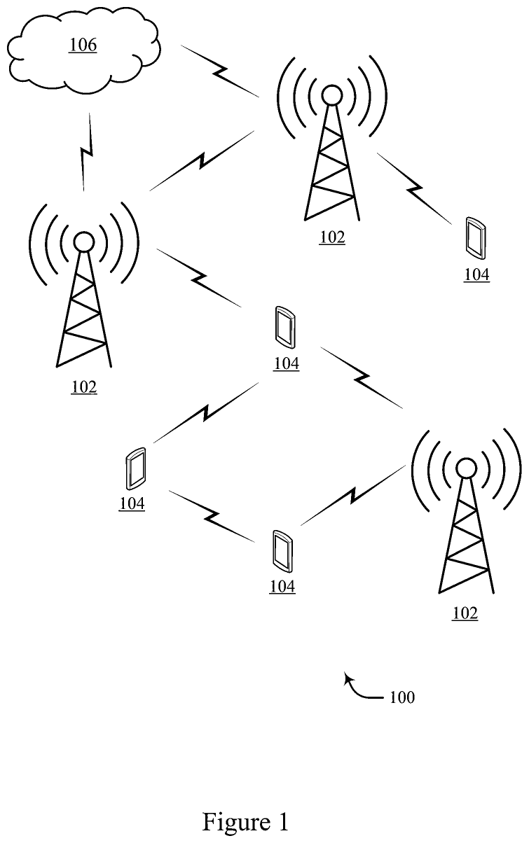

FIG. 1 illustrates an example of a wireless communications system 100 in accordance with aspects of the present disclosure. The wireless communications system 100 may include one or more network equipment NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the CN 106 may include a location management function (LMF), which manages the support of different location services for target UEs, including positioning of UEs and delivery of assistance data to UEs, interacting with multiple NG-RAN nodes to provide assistance data information for broadcasting, and may interact with the AMF to provide (updated) UE positioning capability to the AMF and to receive stored UE positioning capability from the AMF. The LMF can include a control plane entity or user plane entity. In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. In one or more implementations, a NE 102 is representative of any type of communication device, including but not limited to a base station, a location server, a target UE, an anchor UE with or without a known location, a server UE, a client UE, a roadside-unit, or any type of network equipment. Similarly, a UE 104 is representative of any type of communication device, including but not limited to a target UE, an anchor UE with or without a known location, a server UE, a client UE, or a roadside unit.

In one or more implementations, a UE 104 receives a resource allocation configuration to perform SL-PRS transmission over unlicensed carriers, where the resource allocation configuration includes at least RB sets, subchannel sizes, subchannel numbers, and comb-sizes of multiple SL-PRSs. The UE 104 transmits at least one SL-PRS over an unlicensed carrier based at least in part on the resource allocation configuration. Alternatively or additionally, the UE 104 transmits the at least one SL-PRS over one or more unlicensed carriers to multiple communication devices based at least in part on the resource allocation configuration. Alternatively or additionally, the UE transmits multiple SL-PRSs over one or more unlicensed carriers to multiple communication devices based at least in part on the resource allocation configuration.

In one or more implementations, a first communication device receives, from a second communication device, a resource allocation configuration to perform SL-PRS transmission over unlicensed carriers, where the resource allocation configuration includes at least RB sets, subchannel sizes, subchannel numbers, and comb-sizes of multiple SL-PRSs. The first communication device transmits at least one SL-PRS to the second communication device over an unlicensed carrier based at least in part on the resource allocation configuration. Alternatively or additionally, the first communication device transmits the at least one SL-PRS over one or more unlicensed carriers to multiple communication devices based at least in part on the resource allocation configuration. Alternatively or additionally, the first communication device transmits multiple SL-PRSs over one or more unlicensed carriers to multiple communication devices based at least in part on the resource allocation configuration.

With reference to positioning requirements, NR positioning based on NR Uu signals and stand-alone (SA) architecture (e.g., beam-based transmissions) was first specified in Release 16. The targeted use cases also included commercial and regulatory (emergency services) scenarios as in Release 15. The performance requirements are the following:

| Positioning Error | Indoor | Outdoor |
|---|---|---|
| Horizontal Positioning | <3 m for 80% of UEs | <10 m for 80% of UEs |
| Vertical Positioning | <3 m for 80% of UEs | <3 m for 80% of UEs |

Currently 3GPP Release 17 positioning has defined the positioning performance requirements for commercial and IIoT use cases as follows:

| Positioning Error | Commercial | IIoT |
|---|---|---|
| Horizontal Positioning | (<1 m) for | (<0.2 m) for |
| | 90% of UEs | 90% of UEs; |
| Vertical Positioning | (<3 m) for | (<1 m) for |
| | 90% of UEs | 90% of UEs |
| Physical layer latency for | (<10 ms) | (<10 ms) |
| position estimation of UE | | |
| End-to-End Latency for | (<100 ms) | (<100 ms, in |
| position estimation of UE | | the order of |
| | | 10 ms is desired) |

For sidelink positioning in Release 18, various requirements were defined capturing a variety of use cases, as listed in the following table:

| SL | | | | |
|---|---|---|---|---|
| Positioning | | | | |
| KPIs | V2X | Public Safety | IIoT | Commercial |
| Horizontal | Set A (similar to | 1 m for 90% of | Set A: 1 m | 1 m for 90% of |
| Positioning | “Set 2” defined in | UEs (absolute or | for 90% of | UEs (absolute |
| Accuracy | [2]): 1.5 m for | relative) | UEs (absolute | or relative) |
| | 90% of UEs | | or relative) | |
| | (absolute or | | Set B: 0.2 m | |
| | relative) | | for 90% of | |
| | Set B (similar to | | UEs (absolute | |
| | “Set 3” defined in | | or relative) | |
| | [2]): 0.5 m for | | | |
| | 90% of UEs | | | |
| | (absolute or | | | |
| | relative) | | | |
| Vertical | Set A: 3 m for | 2 m (absolute or | Set A: 1 m | 2 m for 90% of |
| Positioning | 90% of UEs | relative between | for 90% of | UEs (absolute |
| Accuracy | (absolute or | 2 UEs) for 90% | UEs (absolute | or relative) |
| | relative) | of UEs | or relative) | |
| | Set B: 2 m for | 0.3 m (relative | Set B: 0.2 m | |
| | 90% of UEs | positioning | for 90% of | |
| | (absolute or | change for 1 UE) | UEs (absolute | |
| | relative) | for 90% of UEs | or relative) | |
| Relative | — | Up to 30 km/h | Up to 30 km/h | Up to 30 km/h |
| Speed | | | | |

| | |
|---|---|
| Angle | Set A: Y = ±15° for 90% of the UEs |
| Accuracy | Set B: Y = ±8° for 90% of the UEs |

NOTE 1:
For evaluated SL positioning methods, the performance results are described in terms of whether each of the two requirements are satisfied, and the percentile of UEs satisfying the target positioning accuracy for a requirement that may not be satisfied with 90%.
NOTE 2:
Target positioning requirements may not necessarily be reached for all scenarios and deployments
NOTE 3:
All positioning techniques may not achieve all positioning requirements in all scenarios.

The supported UE positioning techniques are listed as methods in the following table:

| | | UE-assisted, | NG-RAN | |
|---|---|---|---|---|
| Method | UE-based | LMF-based | node assisted | SUPL |
| A-GNSS | Yes | Yes | No | Yes (UE-based and UE-assisted) |
| OTDOA ^{Notes1, 2} | No | Yes | No | Yes (UE-assisted) |
| E-CID ^{Note 4} | No | Yes | Yes | Yes for E-UTRA (UE-assisted) |
| Sensor | Yes | Yes | No | No |
| WLAN | Yes | Yes | No | Yes |
| Bluetooth | No | Yes | No | No |
| TBS ^{Note 5} | Yes | Yes | No | Yes (MBS) |
| DL-TDOA | Yes | Yes | No | No |
| DL-AOD | Yes | Yes | No | No |
| Multi-RTT | No | Yes | Yes | No |
| NR E-CID | No | Yes | FFS | No |
| UL-TDOA | No | No | Yes | No |
| UL-AoA | No | No | Yes | No |

NOTE 1:
This includes TBS positioning based on PRS signals.
NOTE 2:
In this version of the specification only observed time difference of arrival (OTDOA) based on LTE signals is supported.
NOTE 4:
This includes Cell-ID for NR method.
NOTE 5:
In this version of the specification is for TBS positioning based on metropolitan beacon system (MBS) signals.

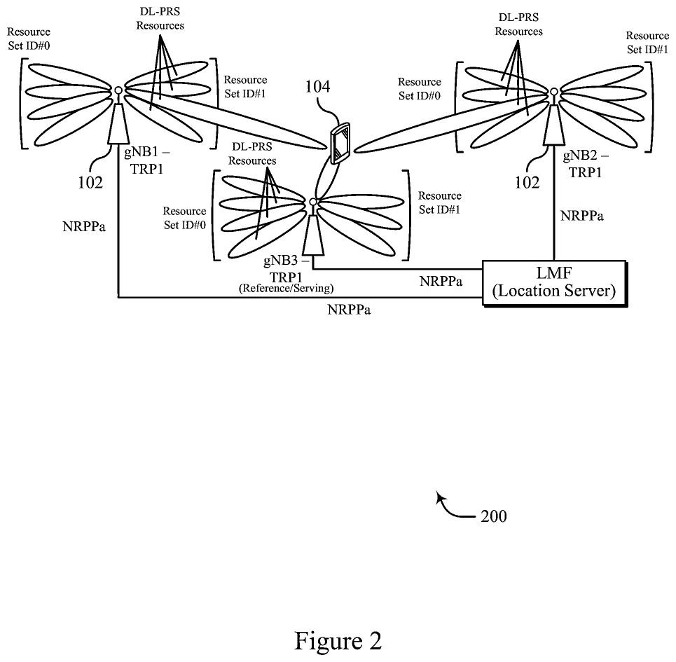

Separate positioning techniques as indicated in the table above can be currently configured and performed based on the requirements of the LMF and UE capabilities. The transmission of Uu (uplink and downlink) PRSs enable the UE to perform UE positioning-related measurements to enable the computation of a UE's absolute location estimate and are configured per transmission reception point (TRP), where a TRP may include a set of one or more beams. A conceptual overview is illustrated in FIG. 2.

FIG. 2 illustrates an example of system 200 for NR beam-based positioning in accordance with aspects of the present disclosure. The system 200 illustrates a UE 104 and NEs 102 (e.g., gNBs). The PRS can be transmitted by different base stations (serving and neighboring) using narrow beams over FR1 and FR2 as illustrated in the example system 200, which is relatively different when compared to LTE where the PRS was transmitted across the whole cell. The PRS can be locally associated with a PRS resource ID and resource set ID for a base station (e.g., a TRP). Similarly, UE positioning measurements, such as reference signal time difference (RSTD) and PRS reference signal received power (RSRP) measurements are made between beams (e.g., between a different pair of downlink (DL) PRS resources or DL PRS resource sets) as opposed to different cells as was the case in LTE. In addition, there are additional uplink positioning methods for the network to exploit in order to compute the target-UE's location.

The tables below show the reference signal (RS) to measurements mapping for each of the supported RAT-dependent positioning techniques at the UE and gNB, respectively. The RAT-dependent positioning techniques may utilize the 3GPP RAT and core network entities to perform the position estimation of the UE, which are differentiated from RAT-independent positioning techniques, which rely on the global navigation satellite system (GNSS), inertial measurement unit (IMU) sensor, wireless local area network (WLAN), and Bluetooth technologies for performing target device (UE) positioning.

TABLE
UE measurements to enable RAT-
dependent positioning techniques.

| | | To facilitate |
|---|---|---|
| | | support of the |
| DL/UL Reference | | positioning |
| Signals | UE Measurements | techniques |
| Rel. 16 DL PRS | DL RSTD | DL-TDOA |
| Rel. 16 DL PRS | DL PRS RSRP | DL-TDOA, |
| | | DL-AoD, |
| | | Multi-RTT |
| Rel.16 DL PRS/Rel.16 | UE Rx-Tx time | Multi-RTT |
| SRS for positioning | difference | |
| Rel. 15 SSB/CSI-RS | SS-RSRP(RSRP for RRM), | NR E-CID |
| for radio resource | SS-RSRQ(for RRM), | |
| management (RRM) | CSI-RSRP (for RRM), | |
| | CSI-RSRQ (for RRM), | |
| | SS-RSRPB (for RRM) | |

TABLE
gNB measurements to enable RAT-dependent
positioning techniques.

| | | To facilitate |
|---|---|---|
| DL/UL Reference | | support of the |
| Signals | gNB Measurements | positioning techniques |
| Rel.16 SRS for | UL RTOA | UL-TDOA |
| positioning | | |
| Rel.16 SRS for | UL SRS-REFERENCE | UL-TDOA, UL-AoA, |
| positioning | SIGNAL RECEIVED | Multi-RTT |
| | POWER (RSRP) | |
| Rel.16 SRS for | gNB Rx-Tx time | Multi-RTT |
| positioning, Rel. | difference | |
| 16 DL PRS | | |
| Rel.16 SRS for | AoA and ZoA | UL-AoA, Multi-RTT |
| positioning | | |

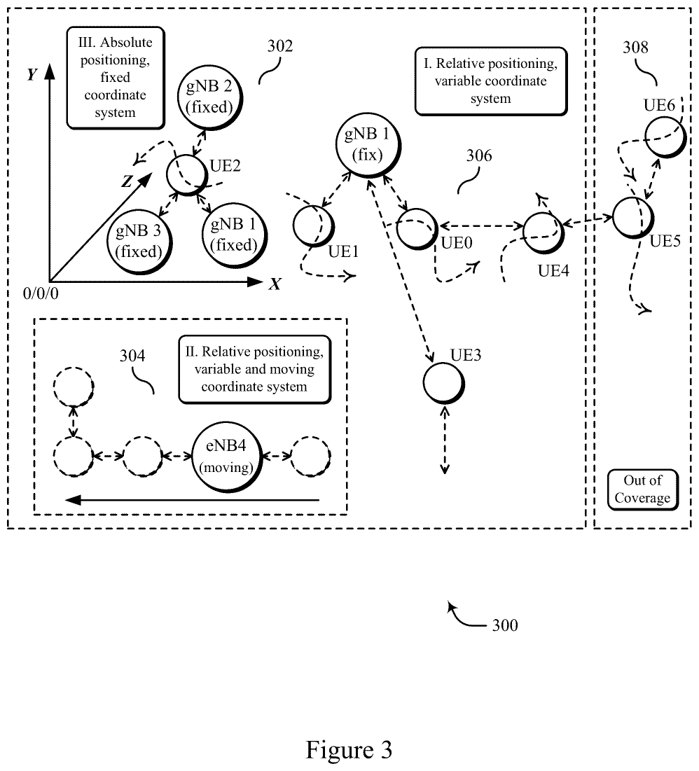

FIG. 3 illustrates an example 300 of absolute and relative positioning scenarios in accordance with aspects of the present disclosure. The network devices described with reference to example 300 may use and/or be implemented with the wireless communications system 100 and include UEs 104 and NEs 102 (e.g., eNB, gNB). The example 300 is an overview of absolute and relative positioning scenarios as defined in the architectural (stage 1) specifications using three different co-ordinate systems, including (III) a conventional absolute positioning, fixed coordinate system at 302; (II) a relative positioning, variable and moving coordinate system at 304; and (I) a relative positioning, variable coordinate system at 306. Notably, the relative positioning, variable coordinate system at 306 is based on relative device positions in a variable coordinate system, where the reference may be always changing with the multiple nodes that are moving in different directions. The example 300 also includes a scenario 308 for an out of coverage area in which UEs need to determine relative position with respect to each other.

The relative positioning, variable and moving coordinate system at 304 may support relative lateral position accuracy of 0.1 meters between UEs supporting V2X applications, and may support relative longitudinal position accuracy of less than 0.5 meters for UEs supporting V2X applications for platooning in proximity. The relative positioning, variable coordinate system at 306 may support relative positioning between one UE and positioning nodes within 10 meters of each other. The relative positioning, variable coordinate system at 306 may also support vertical location of a UE in terms of relative height/depth to local ground level.

Various RAT-dependent positioning techniques are supported in Release 16 and Release 17, such as DL-TDOA, DL-angle of departure (AOD), Multi-RTT, enhanced cell-ID (E-CID)/NR E-CID, uplink (UL)-TDOA, and UL-AOA. The downlink time difference of arrival (DL-TDOA) positioning method makes use of the DL RSTD (and optionally DL PRS RSRP) of downlink signals received from multiple TPs, at the UE. The UE measures the DL RSTD (and optionally DL PRS RSRP) of the received signals using assistance data received from the positioning server, and the resulting measurements are used along with other configuration information to locate the UE in relation to the neighboring TPs.

The DL AOD positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.

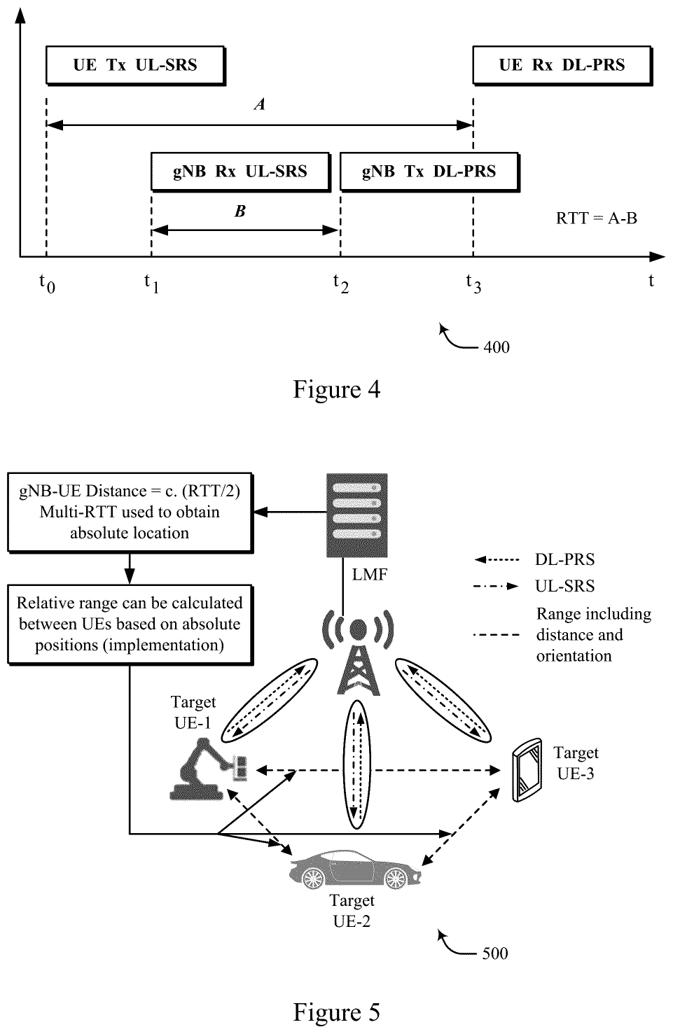

FIG. 4 illustrates an example 400 of a multi-cell RTT procedure in accordance with aspects of the present disclosure. The multi-RTT positioning technique makes use of the UE Rx−Tx measurements and DL PRS RSRP of downlink signals received from multiple TRPs, as measured by the UE and the measured gNB Rx−Tx measurements and uplink sounding reference signal (SRS) RSRP (UL SRS-RSRP) at multiple TRPs of uplink signals transmitted from UE. The UE measures the UE Rx−Tx measurements (and optionally DL PRS RSRP of the received signals) using assistance data received from the positioning server (also referred to herein as the location server), and the TRPs the gNB Rx−Tx measurements (and optionally UL SRS-RSRP of the received signals) using assistance data received from the positioning server. The measurements are used to determine the RTT at the positioning server, which are used to estimate the location of the UE. In Release 16 the multi-RTT is only supported for UE-assisted and NG-RAN assisted positioning techniques as noted in the table above.

FIG. 5 illustrates an example of a system 500 for relative range estimation using a gNB RTT positioning framework in accordance with aspects of the present disclosure. The system 500 illustrates the relative range estimation using the existing single gNB RTT positioning framework. The location server (e.g., LMF) can configure measurements to the different UEs, and then the target-UEs can report their measurements in a transparent way to the location server. The location server can compute the relative distance between two UEs. This approach is high in latency and is not an efficient method in terms of procedures and signaling overhead.

For the NR E-CID positioning technique, the position of a UE is estimated with the knowledge of its serving ng-eNB, gNB, and cell, and is based on LTE signals. The information about the serving ng-eNB, gNB, and cell may be obtained by paging, registration, or other methods. The NR E-CID positioning refers to techniques which use additional UE measurements and/or NR radio resources and other measurements to improve the UE location estimate using NR signals. Although E-CID positioning may utilize some of the same measurements as the measurement control system in the RRC protocol, the UE may not make additional measurements for the sole purpose of positioning (e.g., the positioning procedures do not supply a measurement configuration or measurement control message, and the UE reports the measurements that it has available rather than being required to take additional measurement actions).

The uplink time difference of arrival (UL-TDOA) positioning technique makes use of the UL-relative time-of-arrival (RTOA) (and optionally UL SRS-RSRP) at multiple reception points of uplink signals transmitted from UE. The RPs measure the UL-RTOA (and optionally UL SRS-RSRP) of the received signals using assistance data received from the positioning server, and the resulting measurements are used along with other configuration information to estimate the location of the UE.

The uplink angle of arrival (UL-AoA) positioning technique makes use of the measured azimuth and the zenith of arrival at multiple RPs of uplink signals transmitted from UE. The RPs measure azimuth-AoA (A-AoA) and zenith-AoA (Z-AoA) of the received signals using assistance data received from the positioning server (also referred to herein as the location server), and the resulting measurements are used along with other configuration information to estimate the location of the UE.

Various RAT-independent positioning techniques may also be used, such as network-assisted GNSS techniques, barometric pressure sensor positioning, WLAN positioning, Bluetooth positioning, terrestrial beacon system (TBS) positioning, and motion sensor positioning. Network-assisted GNSS techniques make use of UEs that are equipped with radio receivers capable of receiving GNSS signals. In 3GPP specifications the term GNSS encompasses both global and regional/augmentation navigation satellite systems. Examples of global navigation satellite systems include Global Positioning System (GPS), Modernized GPS, Galileo, Global Navigation Satellite System (GLONASS), and BeiDou Navigation Satellite System (BDS). Regional navigation satellite systems include Quasi Zenith Satellite System (QZSS) while the many augmentation systems are classified under the generic term of Space Based Augmentation Systems (SBAS) and provide regional augmentation services. Network-assisted GNSS techniques may use different GNSSs (e.g., GPS, Galileo, etc.) separately or in combination to determine the location of a UE.

Barometric pressure sensor positioning techniques make use of barometric sensors to determine the vertical component of the position of the UE. The UE measures barometric pressure, optionally aided by assistance data, to calculate the vertical component of its location or to send measurements to the positioning server for position calculation. This technique should be combined with other positioning methods to determine the 3D position of the UE.

WLAN positioning techniques makes use of the WLAN measurements (access point (AP) identifiers and optionally other measurements) and databases to determine the location of the UE. The UE measures received signals from WLAN access points, optionally aided by assistance data, to send measurements to the positioning server for position calculation. Using the measurement results and a references database, the location of the UE is calculated. Additionally or alternatively, the UE makes use of WLAN measurements and optionally WLAN AP assistance data provided by the positioning server to determine its location.

Bluetooth positioning techniques makes use of Bluetooth measurements (beacon identifiers and optionally other measurements) to determine the location of the UE. The UE measures received signals from Bluetooth beacons. Using the measurement results and a references database, the location of the UE is calculated. The Bluetooth methods may be combined with other positioning methods (e.g., WLAN) to improve positioning accuracy of the UE.

TBS positioning techniques make use of a TBS, which includes a network of ground-based transmitters, broadcasting signals only for positioning purposes. Examples of types of TBS positioning signals are MBS (Metropolitan Beacon System) signals and PRSs. The UE measures received TBS signals, optionally aided by assistance data, to calculate its location or to send measurements to the positioning server for position calculation.

Motion sensor positioning techniques makes use of different sensors such as accelerometers, gyros, magnetometers, and so forth to calculate the displacement of UE. The UE estimates a relative displacement based upon a reference position and/or reference time. The UE sends a report comprising the determined relative displacement which can be used to determine the absolute position. This method can be used with other positioning methods for hybrid positioning.

Different downlink measurements used for RAT-dependent positioning techniques include DL PRS-RSRP, DL RSTD, and UE Rx−Tx Time Difference. The following measurement configurations may be used: four (4) Pair of DL RSTD measurements can be performed per pair of cells, and each measurement is performed between a different pair of DL PRS Resources/Resource Sets with a single reference timing; and eight (8) DL PRS RSRP measurements can be performed on different DL PRS resources from the same cell.

The DL PRS reference signal received power (DL PRS-RSRP) is defined as the linear average over the power contributions (in [W]) of the resource elements that carry DL PRS reference signals configured for RSRP measurements within the considered measurement frequency bandwidth. For frequency range 1, the reference point for the DL PRS-RSRP is the antenna connector of the UE. For frequency range 2, DL PRS-RSRP is measured based on the combined signal from antenna elements corresponding to a given receiver branch. For frequency range 1 and 2, if receiver diversity is in use by the UE, the reported DL PRS-RSRP value is not lower than the corresponding DL PRS-RSRP of any of the individual receiver branches. DL PRS-RSRP is applicable for RRC_CONNECTED intra-frequency and RRC_CONNECTED inter-frequency.

The DL RSTD is the downlink relative timing difference between the positioning node j and the reference positioning node i, defined as T_{SubframeRxj}−T_{SubframeRxi}, where T_{SubframeRxj} is the time when the UE receives the start of one subframe from positioning node j, and T_{SubframeRxi} is the time when the UE receives the corresponding start of one subframe from positioning node i that is closest in time to the subframe received from positioning node j. Multiple DL PRS resources can be used to determine the start of one subframe from a positioning node. For frequency range 1, the reference point for the DL RSTD is the antenna connector of the UE. For frequency range 2, the reference point for the DL RSTD is the antenna of the UE. The DL RSTD is applicable for RRC_CONNECTED intra-frequency and RRC_CONNECTED inter-frequency.

The UE receive-transmit (Rx−Tx) time difference is defined as T_{UE-RX}−T_{UE-TX}, where T_{UE-RX} is the UE received timing of downlink subframe #i from a positioning node, defined by the first detected path in time, and T_{UE-TX} is the UE transmit timing of uplink subframe #j that is closest in time to the subframe #i received from the positioning node. Multiple DL PRS resources can be used to determine the start of one subframe of the first arrival path of the positioning node. For frequency range 1, the reference point for T_{UE-RX} measurement shall be the Rx antenna connector of the UE and the reference point for T_{UE-TX} measurement shall be the Tx antenna connector of the UE. For frequency range 2, the reference point for T_{UE-RX} measurement shall be the Rx antenna of the UE and the reference point for T_{UE-TX} measurement shall be the Tx antenna of the UE. The UE Rx−Tx time difference is applicable for RRC_CONNECTED intra-frequency and RRC_CONNECTED inter-frequency.

The DL PRS reference signal received path power (DL PRS-RSRPP) is defined as the power of the linear average of the channel response at the i-th path delay of the resource elements that carry DL PRS signal configured for the measurement, where DL PRS-RSRPP for the 1st path delay is the power contribution corresponding to the first detected path in time. For frequency range 1, the reference point for the DL PRS-RSRPP is the antenna connector of the UE. For frequency range 2, DL PRS-RSRPP is measured based on the combined signal from antenna elements corresponding to a given receiver branch. DL PRS-RSRPP is applicable for RRC_CONNECTED and RRC_INACTIVE.

TABLE
Downlink measurements for downlink-based positioning techniques.
DL PRS reference signal received power (DL PRS-RSRP)

| | |
|---|---|
| Definition | DL PRS-RSRP, is the linear average over the power contributions (in [W]) of |
| | the resource elements that carry DL PRS reference signals configured for |
| | RSRP measurements within the considered measurement frequency |
| | bandwidth. |
| | For frequency range 1, the reference point for the DL PRS-RSRP shall be the |
| | antenna connector of the UE. For frequency range 2, DL PRS-RSRP shall be |
| | measured based on the combined signal from antenna elements corresponding |
| | to a given receiver branch. For frequency range 1 and 2, if receiver diversity |
| | is in use by the UE, the reported DL PRS-RSRP value shall not be lower than |
| | the corresponding DL PRS-RSRP of any of the individual receiver branches. |
| Applicable for | RRC_CONNECTED intra-frequency, |
| | RRC_CONNECTED inter-frequency |

DL reference signal time difference (DL RSTD)

| | |
|---|---|
| Definition | DL reference signal time difference (DL RSTD) is the DL relative timing |
| | difference between the positioning node j and the reference positioning node i, |
| | defined as T_{SubframeRxj} − T_{SubframeRxi}, |
| | Where: |
| | T_{SubframeRxj} is the time when the UE receives the start of one subframe from |
| | positioning node j. |
| | T_{SubframeRxi} is the time when the UE receives the corresponding start of one |
| | subframe from positioning node i that is closest in time to the subframe |
| | received from positioning node j. |
| | Multiple DL PRS resources can be used to determine the start of one subframe |
| | from a positioning node. |
| | For frequency range 1, the reference point for the DL RSTD shall be the |
| | antenna connector of the UE. For frequency range 2, the reference point for |
| | the DL RSTD shall be the antenna of the UE. |
| Applicable for | RRC_CONNECTED intra-frequency |
| | RRC_CONNECTED inter-frequency |

UE Rx − Tx time difference

| | |
|---|---|
| Definition | The UE Rx − Tx time difference is defined as T_{UE-RX} − T_{UE-TX} |
| | Where: |
| | T_{UE-RX} is the UE received timing of downlink subframe #i from a positioning |
| | node, defined by the first detected path in time. |
| | T_{UE-TX} is the UE transmit timing of uplink subframe #j that is closest in time to |
| | the subframe #i received from the positioning node. |
| | Multiple DL PRS resources can be used to determine the start of one subframe |
| | of the first arrival path of the positioning node. |
| | For frequency range 1, the reference point for T_{UE-RX} measurement shall be the |
| | Rx antenna connector of the UE and the reference point for TUE-TX |
| | measurement shall be the Tx antenna connector of the UE. For frequency |
| | range 2, the reference point for T_{UE-RX} measurement shall be the Rx antenna of |
| | the UE and the reference point for T_{UE-TX} measurement shall be the Tx antenna |
| | of the UE. |
| Applicable for | RRC_CONNECTED intra-frequency |
| | RRC_CONNECTED inter-frequency |

DL PRS RSRPP (Reference Signal Received Path Power)

| | |
|---|---|
| Definition | DL PRS reference signal received path power (DL PRS-RSRPP), is defined as |
| | the power of the linear average of the channel response at the i-th path delay |
| | of the resource elements that carry DL PRS signal configured for the |
| | measurement, where DL PRS-RSRPP for the 1st path delay is the power |
| | contribution corresponding to the first detected path in time. |
| | For frequency range 1, the reference point for the DL PRS-RSRPP shall be the |
| | antenna connector of the UE. For frequency range 2, DL PRS-RSRPP shall be |
| | measured based on the combined signal from antenna elements corresponding |
| | to a given receiver branch. |
| Applicable for | RRC_CONNECTED |
| | RRC_INACTIVE |

With reference to unlicensed operation and regulatory requirements, NR operation in the unlicensed bands is introduced in a similar fashion to LTE LAA. Operation in the unlicensed portions of the spectrum should adhere to the regional regulatory requirements, which introduces additional challenges when compared to operation in the licensed spectrum. The regulatory requirements may include ETSI EN 301 893 V2.1.1.

As used herein, listen-before-talk (LBT) clear channel assessment (CCA) is the mechanism by which an equipment (e.g. a UE) applies CCA before using the channel. The maximum channel occupancy time (MCOT) defines the MCOT which should not be greater than 95% fixed frame period (defined by a manufacturer within range between 1 ms and 10 ms) and shall be followed by an idle period until the start of the next fixed frame period such that the idle period is at least 5% of the channel occupancy time, with a minimum of 100 μs. With reference to effective isotropic radiated power (EIRP) and PSD, the energy detection (ED) threshold level (TL) at the input of the receiver shall be proportional to the maximum transmit power (PH) according to the formula which assumes a 0 dBi receive antenna and PH to be specified in dBm e.i.r.p. The power density is the mean equivalent isotropically radiated power (e.i.r.p.) density during a transmission burst.

The occupied channel bandwidth (OCB) shall be between 80% and 100% of the nominal channel bandwidth. In case of smart antenna systems (devices with multiple transmit chains) each of the transmit chains shall meet this requirement. The OCB may change over time and/or based on payload. A remote LAN (RLAN) shall employ a dynamic frequency selection (DFS) function to detect interference from radar systems (radar detection) and to avoid co-channel operation with these systems. The DFS function also provides, on aggregate, a near-uniform loading of the spectrum (uniform spreading). The frequency (FR) reuse is reduced when multiple devices access the same carrier at the same time period. For unlicensed band operations, other devices should be muted when a single device accesses the carrier.

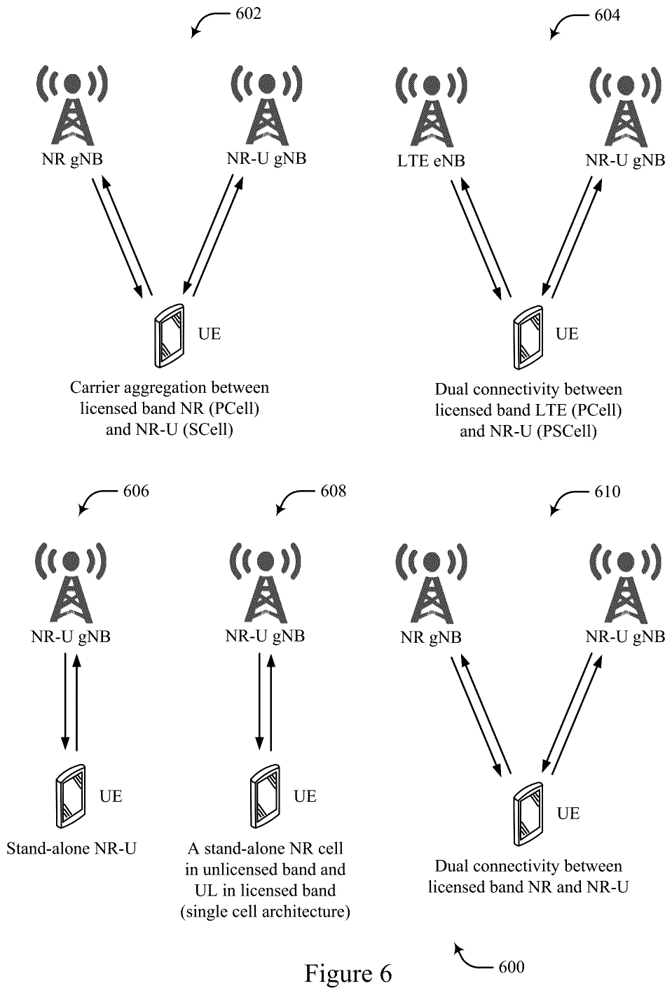

FIG. 6 illustrates an example 600 of various NR-U deployment scenarios in accordance with aspects of the present disclosure. In line with NR development, and in order to maximize the applicability of NR-based unlicensed access, the following scenarios are considered. A scenario 602 illustrates carrier aggregation between a licensed band NR (PCell) and a NR-U (SCell). The NR-U SCell may have both downlink and uplink, or downlink only. In this example scenario 602, the NR PCell is connected to 5G-CN. A scenario 604 illustrates dual connectivity between a licensed band LTE (PCell) and a NR-U (PSCell). In this example scenario 604, the LTE PCell connected to the evolved packet core (EPC) has a higher priority than the PCell connected to 5G-CN. A scenario 606 illustrates a stand-alone NR-U, and the NR-U is connected to 5G-CN. A scenario 608 illustrates a stand-alone NR cell in an unlicensed band and uplink in a licensed band. In this example scenario 608, the NR-U is connected to 5G-CN. A scenario 610 illustrates dual connectivity between a licensed band NR and NR-U. In this example scenario 610, the PCell is connected to 5G-CN. All these scenarios are deemed to be of interest for different applications and/or use cases, and are considered to be feasible. The work on scenario 610, in particular, has also leveraged the work conducted on the WI on “Multi-RAT Dual-Connectivity and Carrier Aggregation enhancements” (LTE_NR_DC_CA_enh-Core). Note that carrier aggregation across NR-U cells was also in the scope of all the above scenarios.

The channel access schemes for NR-based access for unlicensed spectrum can be classified into several categories. Category 1 is immediate transmission after a short switching gap. This is used for a transmitter to immediately transmit after a switching gap inside a COT. The switching gap from reception to transmission is to accommodate the transceiver turnaround time and is no longer than 16 μs. Category 2 is LBT without random back-off. The duration of time that the channel is sensed to be idle before the transmitting entity transmits is deterministic. Category 3 is LBT with random back-off with a contention window of a fixed size. The LBT procedure has the following procedure as one of its components. The transmitting entity draws a random number N within a contention window. The size of the contention window is specified by the minimum and maximum value of N. The size of the contention window is fixed. The random number N is used in the LBT procedure to determine the duration of time that the channel is sensed to be idle before the transmitting entity transmits on the channel. Category 4 is LBT with random back-off with a contention window of variable size. The LBT procedure has the following as one of its components. The transmitting entity draws a random number N within a contention window. The size of contention window is specified by the minimum and maximum value of N. The transmitting entity can vary the size of the contention window when drawing the random number N. The random number N is used in the LBT procedure to determine the duration of time that the channel is sensed to be idle before the transmitting entity transmits on the channel. For different transmissions in a COT and different channels or signals to be transmitted, different categories of channel access schemes can be used.

The following are some non-limiting examples of entities and terminologies that may be referred to in this disclosure. An initiator device can initiate a sidelink positioning/ranging session, and may be implemented as a network entity (e.g., gNB, LMF, etc.) a UE, a roadside unit (RSU), etc. A responder device can respond to a SL positioning/ranging session from an initiator device, and may be implemented as a network entity (e.g., gNB, LMF), a UE, an RSU, etc. A target-UE can represent a UE of interest a position of which (e.g., absolute and/or relative) is to be obtained by an entity such as a network, another UE, and/or by the target-UE itself.

Sidelink positioning refers to positioning a UE using reference signals transmitted over sidelink (e.g., PC5 interface) to obtain absolute position, relative position, ranging information, etc. Ranging refers to a determination of a distance and/or direction between a UE and another entity, e.g., anchor UE. An anchor UE refers to a UE supporting positioning of a target-UE (e.g., by transmitting and/or receiving reference signals for positioning, providing positioning-related information, etc., over the sidelink interface). An anchor UE may additionally or alternatively be referred to as sidelink reference UE, a reference UE, etc.

An assistant UE refers to a UE supporting ranging and/or sidelink between a sidelink reference UE and target-UE over PC5, such as in scenarios where direct ranging and/or sidelink positioning between the sidelink reference UE or anchor UE and the target-UE may not be supported. Measurement results of ranging/sidelink positioning between the assistance UE and the sidelink reference UE, and that between the assistance UE and the target-UE can be determined and used to derive the ranging/sidelink positioning results between target-UE and sidelink reference UE.

A sidelink positioning server UE refers to a UE enabling location calculation for sidelink positioning and ranging-based service. The sidelink positioning server UE can interact with other UE over PC5 to calculate the location of a target-UE. A target-UE and/or sidelink reference UE can act as sidelink positioning server UE. A sidelink positioning client UE refers to a third-party UE (e.g., other than sidelink reference UE and/or the target-UE) which can initiate a ranging/sidelink positioning service request on behalf of an application residing on the sidelink positioning client UE. In implementations a sidelink positioning client UE does not have to support ranging/sidelink positioning capability but a communication between the sidelink positioning client UE and a sidelink reference UE or target-UE may be established (e.g., via PC5, 5GC, etc.) for transmission of a service request and a positioning result.

A sidelink positioning node may refer to a network entity and/or device/UE participating in a sidelink positioning session, e.g., LMF (location server), gNB, UE, RSU, anchor UE, initiator UE, responder UE, etc. A configuration entity refers to a network node and/or other device/UE capable of configuring time-frequency resources and related sidelink positioning configurations. A sidelink positioning server UE may serve as a configuration entity.

Aspects of the described techniques for this disclosure include solutions and implementations for SL-U positioning, while maintaining the minimum channel occupancy and power spectral density (PSD) requirements. In aspects of unlicensed sidelink positioning reference signal transmission and resource allocation, this disclosure details solutions that include support for multiple SL-U SL-PRS physical resource allocation structures, including a first configuration of a common or shared resource pool structure enabling RB-sets defined for SL-PRS transmissions, and for sidelink data (PSSCH) transmissions. The physical resource allocation structures include a second configuration of a common or shared resource pool structure enabling RB-sets, which include SL-PRS transmissions and SL data (PSSCH) transmissions, and include a third configuration of a dedicated resource pool structure enabling RB-sets, which include only SL-PRS transmissions. This disclosure also details solutions that include support to define configurations for interlaced SL-PRS transmission from multiple transmitting UEs, support for SL-PRS Tx and/or Rx frequency hopping across RB-sets based on the interlaces in each RB-set, and support to enable collection of sidelink assistance data error for computing a sidelink positioning integrity result.

One or more of the described solutions and/or implementations may be combined with each other to support unlicensed sidelink positioning reference signal transmission and resource allocation. As used herein, a positioning-related reference signal may be referred to as a reference signal used for positioning procedures or purposes in order to estimate a target-UE's location, such as a PRS, or based on existing reference signals such as channel state information (CSI)-RS or SRS. A target-UE may be referred to as the device or entity to be localized and/or positioned. In various implementations, the term PRS may refer to any signal, such as a reference signal, which may or may not be used primarily for positioning. Additionally, any reference made to position, location information, and/or estimates may refer to an absolute position or a relative position with respect to another node or entity, ranging in terms of distance, ranging in terms of direction, or combination thereof.

Aspects of the present disclosure include various SL-PRS physical resource allocation structures that can be implemented to support unlicensed operations based on resource pools and RB-sets (e.g., categorize the RB-sets). With reference to a SL-U SL-PRS resource allocation scheme, a shared resource pool structure (also referred to herein as a common resource pool structure) can be enabled in terms of RB-sets defined for SL-PRS transmissions, and for SL data (PSSCH) transmissions. A shared resource pool is equivalent to a common resource pool for SL-PRS and sidelink data transmission In another implementation, the SL data transmissions can include 2^{nd} stage sidelink control information (SCI), sidelink shared channel (SL-SCH), and physical sidelink feedback channel (PSFCH) (where applicable). This enables flexible bandwidth allocation of SL-PRS corresponding to the RB-set bandwidth depending on successful LBT channel access.

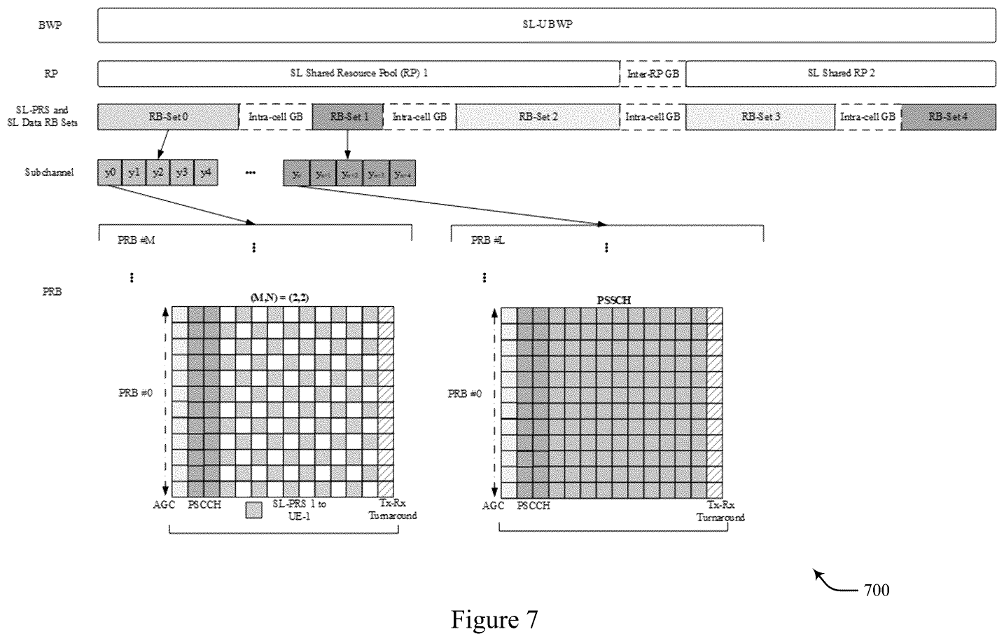

FIG. 7 illustrates an example of a first SL-U SL-PRS PRAS 700 of an unlicensed

shared resource pool, in accordance with aspects of the present disclosure. In this example, the first configuration characteristics of the SL-U SL-PRS PRAS include a UE can be configured with a SL-BWP that includes a shared resource pool structure (also referred to herein as a common shared resource pool structure), where the shared resource pool structure includes one or more RB-sets of SL-PRS only transmissions and one or more RB-sets of sidelink data transmissions (e.g., sidelink shared resource pool (RP) 1={RB-Set 0 for SL-PRS, RB-Set 1 for data, RB-Set 2 for SL-PRS} and shared RP 2={RB-Set 3 for SL-PRS, RB-Set 4 for data}. The SL-PRS bandwidth is at least the same as one or more configured RB-sets. Further, the SL-PRS and/or SL data RB-sets may be configured in a contiguous manner, which will enable multi-channel access (e.g., RB-Set 0 and RB-Set 1 in the example FIG. 7 may be configured to transmit SL-PRS. This will be beneficial for enhanced accuracy where SL-PRS is transmitted over larger BWs reflected over multiple contiguous RB-sets. In addition, the intra-cell (inter-RB-set) guard bands can be used for data or PRS transmissions, as appropriate, for improved spectral efficiency of the transmission. In some implementations, the SL-PRS within the RB-sets may be associated with a priority and may be signaled using layer-1 (e.g., 1^{st} or 2^{nd} stage SCI, or higher layer signaling (e.g., SLPP to the receiving UE for prioritization of sidelink positioning measurements). Multiple priorities may be associated to a shared resource pool or RB-sets within the shared resource pool.

An RB-set configured for SL-PRS may be associated to a configured number of subchannels, which can be characterized by one or more elements, including a SL-PRS resource ID, a SL-PRS resource set ID, a SL-PRS TRP ID, SL-PRS comb offsets and associated SL-PRS comb sizes (N), SL-PRS starting symbols and a number of SL-PRS symbols (M), SL-PRS comprising of fully staggered and partial staggering patterns, and a SL-PRS frequency domain allocation in terms of a number of subchannels (e.g., {y0, . . . , yn+4}, subchannel size={10, 12, 15, 20, 25, 50, 75, 100} PRBs and an associated number of PRBs. In order to enable multiplexed SL-PRS transmissions from different transmitting (Tx) UEs, interlaced RB transmissions may be configured to the RB-sets configured for SL-PRS with P interlaces, which are equally spaced given by a parameter Q RBs between each interlace. Different Tx IDs may be identified in the configuration using source-IDs, a session ID, destination-IDs, or other globally uniquely identifying layer-1 or layer-2 UE IDs (e.g., an anchor UE ID, or UE-IDs such as 5GS-temporary mobile subscriber identity (TMSI)).

The subchannels within a sidelink positioning RB-set are also defined with an associated offset to carrier value, which describes the offset in frequency domain between Point A and the lowest usable subcarrier on the sidelink carrier in number of PRBs. Each SL-PRS subchannel within an RB-set configured for SL-PRS is defined by #M contiguous PRBs, while each sidelink data subchannel within a RB-set configured for SL-Data is defined by #L contiguous PRBs. In an example configuration, each RB-set is assumed to have an LBT bandwidth of 20 MHz, which depends on the subcarrier spacing, therefore an RB-set may include 106 PRBs for 15 kHz SCS, 51 PRBs for 30 kHz SCS, or 24 PRBs for 60 kHz SCS. The Intra-cell guard band PRBs between RB-sets can be configured with various options, including a first option in which the intra-cell guard band PRBs can be configured with additional SL-PRS subchannels to have wider bandwidth, which is an incremental number of PRBs defined by the guard band. In a second option, the intra-cell guard band PRBs can be configured with additional sidelink data subchannels to have a higher data transmission bandwidth, which is an incremental number of PRBs defined by the guard band. In a third option, the above options may be signaled to the UE via lower layer (SCI, medium access control element (MAC CE)) or higher-layer (RRC, SLPP) signaling (e.g., using a flag).

The above configuration characteristics may be signaled from the configuration entity towards the UE or communication device transmitting SL-PRS over unlicensed bands. The configuration entity can be implemented as a gNB, a location server (e.g., LMF, or a UE or communication device, such as a server UE), an anchor UE (reference UE) with or without a known location, and/or a target-UE. Signaling mechanisms to transfer the above SL-U SL-PRS configuration information may include downlink control information (DCI), 1^{st} or 2^{nd} stage SCI, MAC CE, RRC, SLPP (e.g., RequestSLAssistance Data or ProvideSLAssistanceData), or a combination thereof. In another implementation, the above configuration characteristics may be signaled to multiple UEs using broadcast or groupcast signaling (e.g., using normal system information block (SIB) or posSIB information). New SIBs may be defined for this purpose, or existing SIBs may be extended to accommodate this configuration information.

In another configuration, a common or shared resource pool structure can be enabled in terms of RB-sets, which include SL-PRS transmissions and sidelink data (PSSCH) transmissions. In implementations, the sidelink data transmissions include 2nd Stage SCI, SL-SCH, and PSFCH (where applicable). This enables flexible bandwidth allocation of SL-PRS corresponding to the RB-set bandwidth.

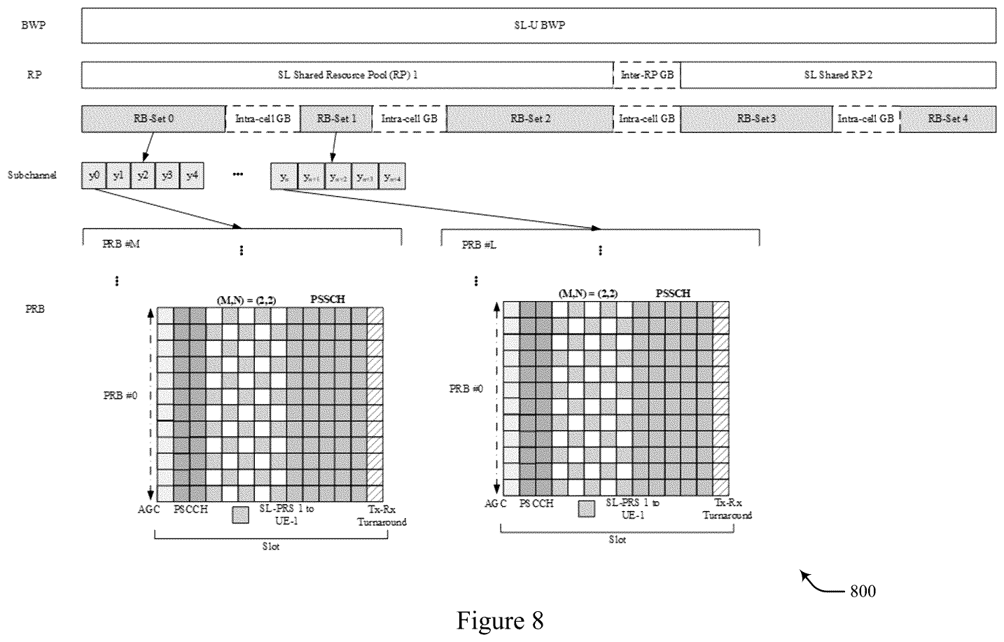

FIG. 8 illustrates an example of a second SL-U SL-PRS PRAS 800 of an unlicensed shared resource pool, in accordance with aspects of the present disclosure. In this example, the second configuration characteristics of the SL-U SL-PRS PRAS include a UE can be configured with a SL-BWP that includes a shared resource pool structure (also referred to herein as a common shared resource pool structure), where the shared resource pool structure includes one or more RB-sets comprising SL-PRS transmissions and sidelink data transmissions (e.g., sidelink shared resource pool (RP) 1={RB-Set 0, RB-Set 1, RB-Set 2} and shared RP 2={RB-Set 3, RB-Set 4}, where each RB-set is configured to support shared transmission of SL-PRS, as well as SL-Data. Within this shared RB-set, the SL-PRS is time division multiplexed (TDMed) with the PSSCH. The SL-PRS bandwidth is at least the same as the PSSCH bandwidth. The SL-PRS comb-size configuration within one or more shared RB-sets may be configured with the same or different comb size configuration depending on the number of symbols allocated to SL-PRS within a slot, which will enable multi-channel access (e.g., according to FIG. 8), RB-set 0 and RB-Set 1 may have a same comb size configuration of SL-PRS of (2,2) or in another implementation, RB-set 0 may have a comb size configuration of (2,2) and RB-set 1 may have a comb size configuration of (4, 4). This will be beneficial for flexible SL-PRS configurations over different RB-sets which may depend on the requested location accuracy. In some implementations, the SL-PRS within the RB-sets may be associated with a priority and may be signaled using layer-1 (e.g., 1^{st} or 2^{nd} stage SCI), or higher layer signaling (e.g., SLPP to the receiving UE for prioritization of sidelink positioning measurements. Multiple priorities may be associated to a shared resource pool or RB-sets within the shared resource pool.

The shared SL-PRS and SL Data RB-set can be associated with a configured number of subchannels, which may be characterized by one or more elements, including a SL-PRS resource ID, a SL-PRS resource set ID, a SL-PRS TRP ID, SL-PRS comb offsets and associated SL-PRS comb sizes (N), SL-PRS starting symbols and a number of SL-PRS symbols (M), SL-PRS that includes fully staggered and partial staggering patterns, and SL-PRS frequency domain allocation in terms of a number of subchannels (e.g., {y0, . . . , yn+4}, subchannel size={10, 12, 15, 20, 25, 50, 75, 100} PRBs and an associated number of PRBs. Further, at least one of a starting symbol number of SL-PRS within a slot; an ending symbol number of SL-PRS within a slot; a number of SL-PRS symbols within a slot; a starting symbol number of PSSCH within a slot; an ending symbol number of PSSCH within a slot; a number of PSSCH symbols within a slot; a switching symbol number for switching from SL-PRS to PSSCH; a switching symbol number for switching from PSSCH to SL-PRS; a location of an automatic gain control (AGC) symbol when switching from SL-PRS to PSSCH; a location of an AGC symbol when switching from PSSCH to SL-PRS.

In order to enable multiplexed SL-PRS transmissions from different transmitting UEs, interlaced RB transmissions can be configured to the shared SL-PRS and SL-Data RB-sets with P-interlaces, which are equally spaced given by a parameter Q RBs between each interlace. The subchannels within the shared SL-PRS and SL-Data RB-sets are also defined with an associated offset to carrier value, which describes the offset in frequency domain between Point A and the lowest usable subcarrier on the sidelink carrier in number of PRBs. Each SL-PRS subchannel within the shared SL-PRS and SL-Data RB-sets is defined by #M contiguous PRBs, while each sidelink data subchannel within a SL-Data RB-set is defined by #L contiguous PRBs. Each shared SL-PRS and SL-Data RB-sets is at least configured to the LBT bandwidth of 20 MHz, which depends on the subcarrier spacing of 106 PRBs for 15 kHz SCS, 51 PRBs for 30 kHz SCS, or 24 PRBs for 60 kHz SCS. The intra-cell guard band PRBs between RB-sets may be configured with various options, including an option that the intra-cell guard band PRBs can be configured with additional shared subchannels to either accommodate more SL-PRS symbols or more PSSCH symbols within a slot, which is an incremental number of PRBs defined by the guard band. This option may be signaled to the UE via lower layer (SCI, MAC CE) or higher-layer (RRC, SLPP) signaling (e.g., using a flag).

The above configuration characteristics can be signaled from the configuration entity towards the UE or communication device transmitting SL-PRS and/or sidelink data over unlicensed bands. In the case that the Rx UE indicates or requests receiving either SL-PRS or sidelink data, the Rx UE can receive a configuration information element related to the part of the slot that contains the desired reception signals and/or channels. The configuration entity can be implemented as a gNB, a location server (e.g., LMF, or a UE or communication device, such as a server UE), an anchor UE (reference UE) with or without a known location, or and/or a target-UE. Signaling mechanisms to transfer the SL-U SL-PRS configuration information can include DCI, 1^{st} or 2^{nd} stage SCI, MAC CE, RRC, SLPP (e.g., RequestSLAssistanceData or ProvideSLAssistanceData), or a combination thereof. In implementations, the above configuration characteristics can be signaled to multiple UEs using broadcast or groupcast signaling (e.g., using normal SIB or posSIB information). New SIBs can be defined for this purpose or existing SIBs may be extended to accommodate this configuration information.

In another configuration, a dedicated resource pool structure can be enabled in terms of RB-sets, which includes only SL-PRS transmissions. These RB-sets can include one or more contiguous RB-sets to transmit SL-PRS over wider bandwidth depending on successful LBT channel access.

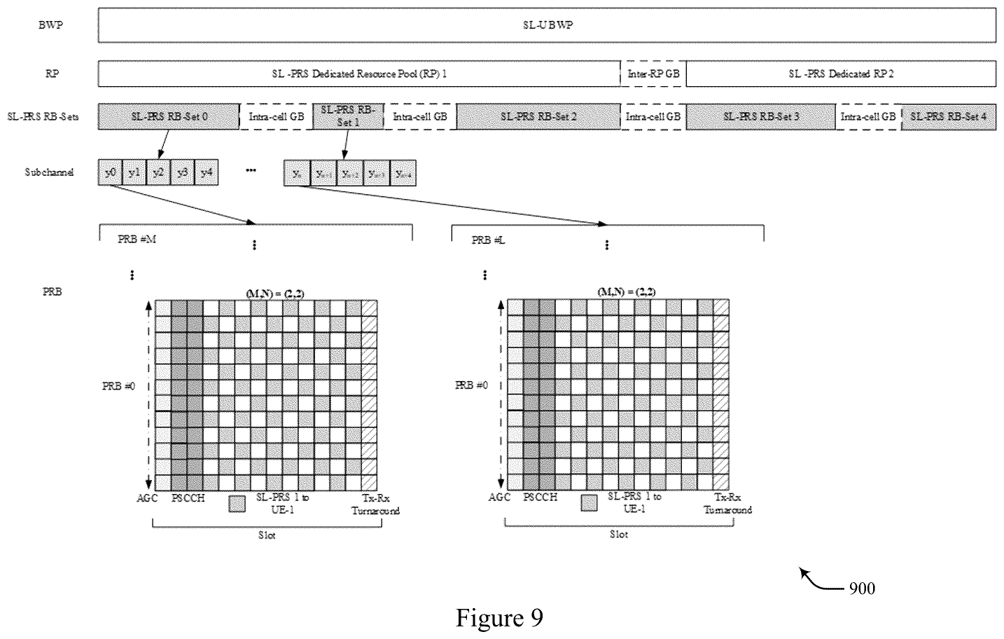

FIG. 9 illustrates an example of a third SL-U SL-PRS PRAS 900, in accordance with aspects of the present disclosure. In this example, the third configuration characteristics of the SL-U SL-PRS PRAS include a UE can be configured with a SL-BWP that includes a dedicated SL-PRS resource pool structure, where this dedicated SL-PRS resource pool structure includes one or more RB-sets comprising only SL-PRS transmissions (e.g., SL-PRS only resource pool (RP) 1={SL-PRS RB-Set 0, SL-Data RB-Set 1, SL-PRS RB-Set 2} and shared RP 2={SL-PRS RB-Set 3, SL Data RB-Set 4}. Noting that SL-PRS only implies that the RB-set includes physical sidelink control channel (PSCCH) (control), which may schedule SL-PRS transmissions. Within this SL-PRS only RB-set, multiple (M,N) comb size configurations within a slot are supported only when the different (M, N) pairs are always multiplexed via TDM to different sets of symbols in a slot. The SL-PRS comb-size configuration within one or more SL-PRS only RB-sets can be configured with the multiple (M,N) comb size configurations in TDMed configuration, depending on the number of symbols allocated to each SL-PRS comb-size configuration within a slot, which will enable multi-channel access. For example, according to FIG. 9, in one implementation, RB-set 0 and RB-Set 1 may have the same comb size configuration of SL-PRS of (2,2) or in another implementation, RB-set 0 may have a comb size configuration of (2,2), and RB-set 1 may have a comb size configuration of (4, 4). This will be beneficial for flexible SL-PRS configurations over different RB-sets which may depend on the requested location accuracy. In other implementations, multiple SL-PRS comb size configurations with different (M,N) pairs can be configured within a single slot in a TDM manner.

The SL-PRS bandwidth is at least the same as the RB-set bandwidth and in the case of multi-channel access, the SL-PRS bandwidth may be at least same as the RP bandwidth. The SL-PRS RB-sets can be configured in a contiguous manner, which will enable multi-channel access (e.g., RB-set 0, RB-Set 1, and RB-Set 2 in FIG. 9 can be configured to transmit SL-PRS depending on successful LBT). This will be beneficial for enhanced accuracy where the configured SL-PRS may be transmitted over larger BWs within a RP reflected over multiple contiguous RB-sets. The SL-PRS RB-set can be associated with a configured number of subchannels, which may be characterized by one or more elements, including a SL-PRS resource ID, a SL-PRS resource set ID, a SL-PRS TRP ID, SL-PRS comb offsets and associated SL-PRS comb sizes (N), SL-PRS starting symbols and a number of SL-PRS symbols (M), SL-PRS that includes fully staggered and partial staggering patterns, SL-PRS frequency domain allocation in terms of a number of subchannels (e.g., {y0, . . . , yn+4}, subchannel size={10, 12, 15, 20, 25, 50, 75, 100} PRBs and an associated number of PRBs.

In order to enable multiplexed SL-PRS transmissions from different transmitting UEs, interlaced RB transmissions can be configured to the shared SL-PRS and SL-Data RB-sets with P interlaces, which are equally spaced given by a parameter Q RBs between each interlace. The subchannels within the SL-PRS only RB-sets are also defined with an associated offset to carrier value, which describes the offset in frequency domain between Point A and the lowest usable subcarrier on the sidelink carrier in a number of PRBs. Each SL-PRS subchannel within the SL-PRS only RB-sets is defined by #M contiguous PRBs, while each sidelink data subchannel within a SL-Data RB-set is defined by #L contiguous PRBs. For example, each SL-PRS only RB-sets is at least configured to the LBT bandwidth of 20 MHz, which depends on the subcarrier spacing of 106 PRBs for 15 kHz SCS, 51 PRBs for 30 kHz SCS, or 24 PRBs for 60 kHz SCS. The intercell guard band PRBs between SL-PRS only RB-sets can be configured with an option that the intercell guard band PRBs may be configured with additional SL-PRS only subchannels to accommodate more SL-PRS symbols, which provides a wider bandwidth. The option can be signaled to the UE via lower layer (SCI, MAC CE) or higher-layer (RRC, SLPP) signaling (e.g., using a flag).

The above configuration characteristics can be signaled from the configuration entity towards the UE or communication device transmitting SL-PRS over unlicensed bands. The configuration entity may be a gNB, a location server (e.g., LMF, or UE or communication device, such as a server UE), an anchor UE (reference UE) with or without a known location, and/or a target-UE. Signaling mechanisms to transfer the above SL-U SL-PRS configuration information can include DCI, 1^{st} or 2^{nd} stage SCI, MAC CE, RRC, SLPP (e.g., RequestSLAssistanceData or ProvideSLAssistanceData), or a combination thereof. In other implementations, the configuration characteristics can be signaled to multiple UEs using broadcast or groupcast signaling (e.g., using normal SIB or posSIB information). New SIBs can be defined for this purpose, or existing SIBs may be extended to accommodate this configuration information.

With reference to interlacing SL-PRS transmissions, the time-frequency resources to perform sidelink positioning over the unlicensed band should be configured such that PSD and minimum channel occupancy requirements are satisfied, while achieving the target accuracy (e.g., absolute, relative horizontal, and/or vertical accuracy requirements). A solution to satisfy the occupied channel bandwidth and PSD requirement is to perform interlaced SL-PRS transmissions, considering a SL-PRS resource-based allocation scheme. In this case, interlaced SL-PRS transmissions can enable multiplexing of different SL-PRS transmissions over the LBT bandwidth. This implies that SL-PRS resources are defined with respect to a slot, which is characterized by a SL PRS resource ID, a SL-PRS resource set ID, a SL-PRS TRP ID, SL-PRS comb offsets and associated SL-PRS comb sizes (N), SL-PRS starting symbols and a number of SL-PRS symbols (M), SL-PRS frequency domain allocation in terms of subchannel size and associated number of PRBs. In the context of a common or shared positioning resource pool containing SL-PRS and sidelink data, the combination of a SL PRS resource ID and frequency domain allocation may uniquely identify a SL-PRS resource within a slot. The SL-PRS resources defined with respect to a slot can also be characterized by a SL-PRS resource set ID, SL-PRS dedicated resource pool consisting of SL-PRS control (e.g., PSCCH and SL-PRS only transmissions), SL-PRS common or shared pool consisting of SL-PRS control (e.g., PSCCH, PSSCH (sidelink data) and SL-PRS transmissions), SL-BWP, and/or sidelink carrier.

The frequency domain granularity of sidelink consists of sub-channels, which are defined as a set of contiguous PRBs, and may be extended to SL-U SL-PRS transmissions. Therefore, in aspects of the described techniques, the SL-PRS resource configuration and corresponding transmission behavior may correspond to a set of P interlaces per subchannel. This set of P interlaces are applied to time-frequency resources used for positioning purposes. In other implementations, this set of P interlaces correspond to time-frequency resources used for data and positioning. In an extended implementation, the set of P interlaces may be equally or unequally spaced apart with Q interlaces spacings. If multiple interlaces are spaced equally, then a single Q value may be configured, however if there are multiple unequal spacing between interlaces, then multiple Q values may be configured starting from the lowest subchannel (e.g., Q1, Q2, Q3, etc.) depending on the number unequal interlaces.

In other implementations, a single interlace may be equally or unequally spaced apart with Q PRBs (e.g., for a given SL-PRS subchannel associated to a RB-set, Q spacings between PRBs of the same interlace can be configured. If multiple PRBs are spaced equally, then a single Q value can be configured, however if there are multiple unequal spacing between PRBs, then multiple Q values can be configured starting from the lowest PRB (e.g., Q1, Q2, Q3, etc.) depending on the number of unequal interlaces.

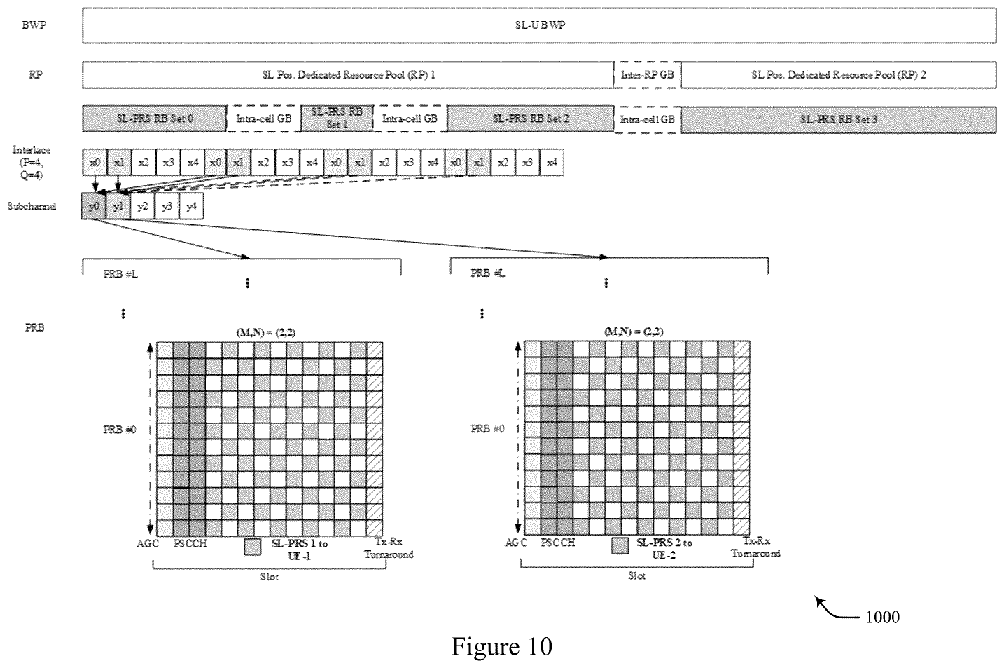

A key aspect is that the interlaces and subchannel size correspond to a LBT bandwidth of 20 MHz and meet the minimum occupied channel bandwidth requirements as per the regulatory requirements, which may be referred to as an RB-set. Therefore, the SL-U SL-PRS (pre-)configuration may be characterized by at least one or more configuration elements, including a subchannel size (in PRBs) and a number of subchannels, where each subchannel is configured with P interlaces spaced by Q PRBs. In implementations, the Q value may reflect equal spacing between interlaces or in another implementation, the Q value may reflect unequal spacing between interlaces. The one or more configuration elements also include an interlacing index according to various options, including a first option for an interlacing index starting from the lowest subcarrier and incremented until the highest subcarrier index, and a second option for an interlacing index as a function of the number of interlaces within an RB-set as depicted in FIG. 10. The one or more configuration elements also include a number of SL-PRS interlaces associated to an RB-set, and each RB-set is at least configured to the LBT bandwidth of 20 MHz, which depends on the subcarrier spacing as 106 PRBs for 15 kHz SCS, 51 PRBs for 30 kHz SCS, or 24 PRBs for 60 kHz SCS. The one or more configuration elements also include: an offset to carrier associated with each interlace, wherein the start of the carrier corresponds to the lowest subchannel index or frequency location within a configured resource pool; a SL-PRS resource pool identified by a pre-defined ID corresponding to either a SL-PRS dedicated resource pool, or common or shared resource pool; different Tx IDs may be identified in the configuration using source-IDs, a session ID, destination-IDs, or other globally uniquely identifying layer-1 or layer-2 UE IDs (e.g., an anchor UE ID, UE-IDs such as 5GS-TMSI.A SL PRS resource ID); SL-PRS comb offsets and associated SL-PRS comb sizes (N); SL-PRS starting symbols and a number of SL-PRS symbols (M); a SL BWP identified by a pre-defined ID; and/or a sidelink carrier identified by a pre-defined ID.

FIG. 10 illustrates an example 1000 of an SL-U interlaced SL-PRS configuration for multiplexing different SL-PRS transmissions, in accordance with aspects of the present disclosure. According to an aspect of the described techniques, the SL-U interlaced SL-PRS configuration can be signaled from a configuration entity, such as a base station (e.g., a gNB, a location server, a sidelink positioning server UE, an anchor UE, or target-UE). Examples of the signaling can include UE-specific signaling, or unicast, groupcast, or broadcast signaling, which may be carried via LTE positioning protocol (LPP), SLPP, RRC, positioning SIBs, and/or normal SIBs.

In this example, the configuration characteristics can be signaled from the configuration entity to the UE or communication device transmitting SL-PRS over unlicensed bands. The configuration entity may be implemented as a gNB, a location server (e.g., a LMF, or a UE or communication device, such as a server UE, an anchor UE (reference UE) with or without a known location, and/or a target-UE). Signaling mechanisms to transfer the above SL-U SL-PRS configuration information can include DCI, 1^{st} or 2^{nd} stage SCI, MAC CE, RRC, SLPP (e.g., RequestSLAssistanceData or ProvideSLAssistanceData), or a combination thereof. In other implementations, the above configuration characteristics can be signaled to multiple UEs using broadcast or groupcast signaling (e.g., using normal SIB or posSIB information). New SIBs can be defined for this purpose, or existing SIBs may be extended to accommodate this configuration information.

With reference to SL-U SL-PRS Tx and Rx frequency hopping, a UE can be implemented to perform transmit frequency hopping of SL-PRS across RB-sets as a function of a number of hops, which is equivalent to the number of interlaces for its own SL-PRS transmission.

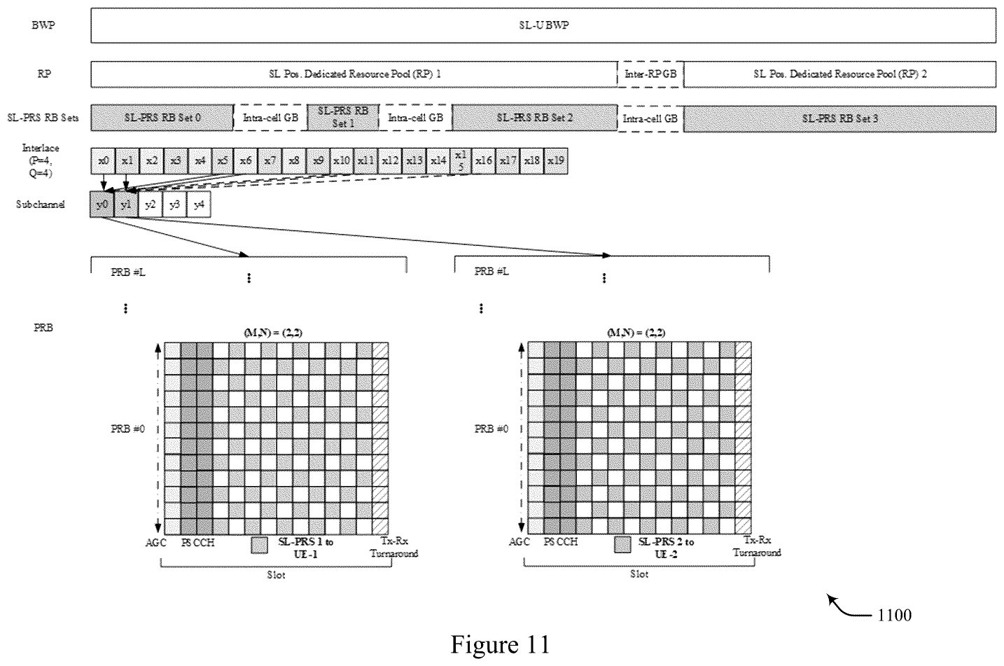

FIG. 11 illustrates an example 1100 of Tx and/or Rx frequency hopping of SL-PRS using the interlace structure, in accordance with aspects of the present disclosure. This example is illustrative of frequency hopping of two UEs performing SL-PRS using the interlace structure. As illustrated in the FIG. 11, UE-1 performs SL-PRS Tx frequency hopping across RB-sets based on interlace indices {RB-set 0, RB-set 1, RB-set 2, RB-set 3}={x0, x2, x4, x6, x8, x10, x12, x14, x16, x18} while UE-2 performs SL-PRS Tx frequency hopping across RB-sets based on interlaces {RB-set 0, RB-set 1, RB-set 2, RB-set 3}={x1, x3, x5, x7, x9, x11, x13, x15, x17, x19}. This enables UE-1 and UE-2 to exploit its allocated interlaces as part of a wider frequency hopping configuration in order to provide a wider bandwidth measurement across different LBT bandwidths (multiple RB-sets).

The UE (UE-1 and/or UE-2) can transmit the SL-PRS Tx frequency hopping configuration based on various information elements, including any one or more sidelink positioning measurements, including RSTD (SL-TDOA DL-type), SL-RTOA (SL-TDOA UL-type), SL-AOA, UE Rx−Tx time difference measurements including RTT-type solutions using sidelink single-sided and/or RTT-type solutions using sidelink double-sided, which can be derived over multiple hops corresponding to the interlaces of each RB-set. The various information elements also include a time duration between hops across RB-sets depending on LBT success or failure corresponding to each RB-set, RF switching time between hops, and ensure that the numerology and bandwidth between hops are the same across RB-sets. In other implementations, the numerologies and bandwidths of different RB-sets may be different. Further, each interlace is associated with #L PRBs. In another implementation, the above configuration may also be equally applicable to a Rx frequency hopping configuration, where a UE can receive SL-PRS across multiple Rx frequency hops across different RB-sets.

The above configuration characteristics can be signaled from the configuration entity to the UE or communication device transmitting SL-PRS over unlicensed bands. The configuration entity may be a gNB, a location server (e.g., a LMF, or UE or communication device, such as a server UE, an anchor UE (reference UE) with or without a known location, a target-UE. Signaling mechanisms to transfer the above SL-U SL-PRS configuration information can include DCI, 1^{st} or 2^{nd} stage SCI, MAC CE, RRC, SLPP (e.g., RequestSLAssistanceData or ProvideSLAssistanceData) or a combination thereof. In another implementation, the above configuration characteristics can be signaled to multiple UEs using broadcast or groupcast signaling (e.g., using normal SIB or posSIB information). New SIBs can be defined for this purpose, or existing SIBs may be extended to accommodate this configuration information. In some implementations, aspects of the resource configuration from FIGS. 7 through 11 may be applicable to Mode 1/Scheme 1—centralized resource allocation schemes, or Mode 2/Scheme 2—distributed and autonomous resource allocation schemes.

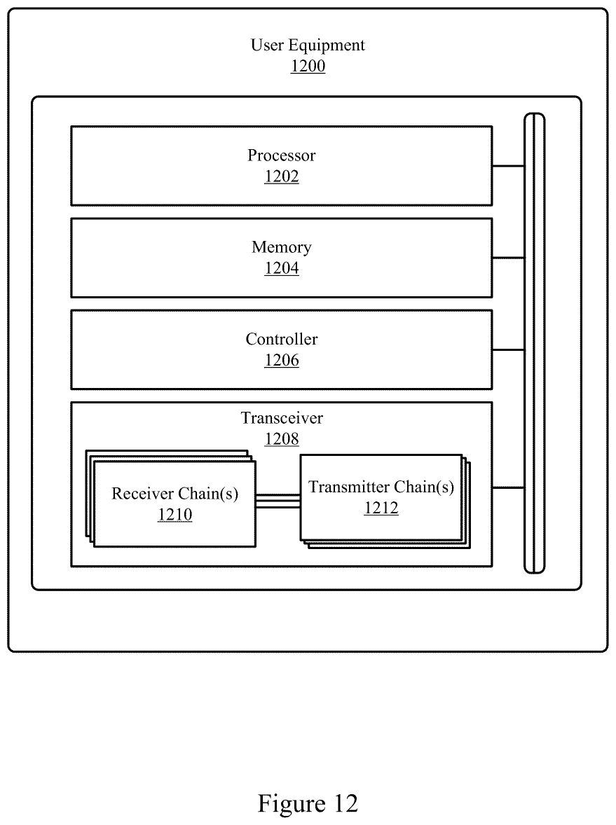

FIG. 12 illustrates an example of a UE 1200 in accordance with aspects of the present disclosure. The UE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the UE 1200 to perform various functions of the present disclosure.

The memory 1204 may include volatile or non-volatile memory. The memory 1204 may store computer-readable, computer-executable code including instructions when executed by the processor 1202 cause the UE 1200 to perform various functions described herein. The code may be stored in a non-transitory computer-readable medium such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the UE 1200 to perform one or more of the functions described herein (e.g., executing, by the processor 1202, instructions stored in the memory 1204). For example, the processor 1202 may support wireless communication at the UE 1200 in accordance with examples as disclosed herein. The UE 1200 may be configured to or operable to support a means for receiving a resource allocation configuration to perform SL-PRS transmission over unlicensed carriers, the resource allocation configuration comprising at least RB sets, subchannel sizes, subchannel numbers, and comb-sizes of multiple SL-PRSs; and transmitting at least one SL-PRS over an unlicensed carrier based at least in part on the resource allocation configuration.

Additionally, the UE 1200 may be configured to support any one or combination of the method further comprising transmitting the at least one SL-PRS over one or more unlicensed carriers to multiple communication devices based at least in part on the resource allocation configuration. The method further comprising transmitting multiple SL-PRSs over one or more unlicensed carriers to multiple communication devices based at least in part on the resource allocation configuration. The method further comprising transmitting a resource allocation configuration request, and in response, receiving the resource allocation configuration. The resource allocation configuration is pre-configured by at least one of the UE or a communication device. The UE is at least one of a target UE, an anchor UE with or without a known location, a server UE, a client UE, or a roadside unit. The method further comprising transmitting the at least one SL-PRS over the unlicensed carrier to a communication device, the communication device being at least one of a base station, a location server, a target UE, an anchor UE with or without a known location, a server UE, a client UE, or a roadside-unit. The resource allocation configuration indicates a shared resource pool structure with at least one of RB sets defined for SL-PRS and associated sidelink control information, or the RB sets defined for sidelink data and the associated sidelink control information. The resource allocation configuration indicates a shared resource pool structure with RB sets defined for SL-PRS, sidelink data, and associated sidelink control information. The resource allocation configuration indicates a dedicated resource pool structure with RB sets defined for SL-PRS and associated sidelink control information. The resource allocation configuration comprises at least one of a sidelink BWP, a sidelink positioning resource pool defined in terms of the RB sets, a SL-PRS bandwidth indication, or an indication of contiguous PRB resource allocation or interlaced PRS resource allocation. A sidelink positioning RB set configuration comprises at least one of multiple SL-PRS resource IDs, SL-PRS resource set IDs, SL-PRS transmission-reception point IDs, SL-PRS comb offsets and associated SL-PRS comb sizes,

SL-PRS starting symbols and a number of SL-PRS symbols, a number of subchannels, or a channel size. A sidelink positioning RB set configuration comprises multiple interlaced transmissions for SL-PRS RB sets with a number of interlaces that are equally spaced according to a parameter that indicates the number of interlaces or RBs between each of the multiple interlaced RB transmissions. The sidelink positioning RB set configuration is associated with different sidelink positioning transmitters differentiated by IDs comprising at least one of a source-ID, a session-ID, a destination-ID, a unique layer-1 ID, or a unique layer-2 ID. Signaling for the resource allocation configuration includes at least one of a lower-layer UE-specific signaling, a higher-layer UE-specific signaling, or broadcast signaling. Intra-cell guard bands are configured for sidelink data or the SL-PRS transmission. At least one of a transmit frequency hopping for SL-PRS or a receive frequency hopping for SL-PRS is enabled across the RB sets based at least in part on a received frequency hopping configuration comprising one or more sidelink positioning measurements corresponding to at least one of one or more hops, a time between the one or more hops, a same numerology and bandwidth among the one or more hops, a different numerology and bandwidth among the one or more hops, or a switching time between the one or more hops.

Additionally, or alternatively, the UE 1200 may support at least one memory and at least one processor coupled with the at least one memory and configured to cause the UE to: receive a resource allocation configuration to perform SL-PRS transmission over unlicensed carriers, the resource allocation configuration comprising at least RB sets, subchannel sizes, subchannel numbers, and comb-sizes of multiple SL-PRSs; and transmit at least one SL-PRS over an unlicensed carrier based at least in part on the resource allocation configuration.

Additionally, the UE 1200 may be configured to support any one or combination of the at least one processor is configured to cause the UE to transmit the at least one SL-PRS over one or more unlicensed carriers to multiple communication devices based at least in part on the resource allocation configuration. The at least one processor is configured to cause the UE to transmit the multiple SL-PRSs over one or more unlicensed carriers to multiple communication devices based at least in part on the resource allocation configuration. The at least one processor is configured to cause the UE to transmit a resource allocation configuration request, and in response, receive the resource allocation configuration. The resource allocation configuration is pre-configured by at least one of the UE or a communication device. The UE is at least one of a target UE, an anchor UE with or without a known location, a server UE, a client UE, or a roadside unit. The at least one processor is configured to cause the UE to transmit the at least one SL-PRS over the unlicensed carrier to a communication device, the communication device being at least one of a base station, a location server, a target UE, an anchor UE with or without a known location, a server UE, a client UE, or a roadside-unit. The resource allocation configuration indicates a shared resource pool structure with at least one of RB sets defined for SL-PRS and associated sidelink control information, or the RB sets defined for sidelink data and the associated sidelink control information. The resource allocation configuration indicates a shared resource pool structure with RB sets defined for SL-PRS, sidelink data, and associated sidelink control information. The resource allocation configuration indicates a dedicated resource pool structure with RB sets defined for SL-PRS and associated sidelink control information. The resource allocation configuration comprises at least one of a sidelink BWP, a sidelink positioning resource pool defined in terms of the RB sets, a SL-PRS bandwidth indication, or an indication of contiguous PRB resource allocation or interlaced PRS resource allocation. A sidelink positioning RB set configuration comprises at least one of multiple SL-PRS resource IDs, SL-PRS resource set IDs, SL-PRS transmission-reception point IDs, SL-PRS comb offsets and associated SL-PRS comb sizes, SL-PRS starting symbols and a number of SL-PRS symbols, a number of subchannels, or a channel size. A sidelink positioning RB set configuration comprises multiple interlaced transmissions for SL-PRS RB sets with a number of interlaces that are equally spaced according to a parameter that indicates the number of interlaces or RBs between each of the multiple interlaced RB transmissions. The sidelink positioning RB set configuration is associated with different sidelink positioning transmitters differentiated by IDs comprising at least one of a source-ID, a session-ID, a destination-ID, a unique layer-1 ID, or a unique layer-2 ID. Signaling for the resource allocation configuration includes at least one of a lower-layer UE-specific signaling, a higher-layer UE-specific signaling, or broadcast signaling. Intra-cell guard bands are configured for sidelink data or the SL-PRS transmission. At least one of a transmit frequency hopping for SL-PRS or a receive frequency hopping for SL-PRS is enabled across the RB sets based at least in part on a received frequency hopping configuration comprising one or more sidelink positioning measurements corresponding to at least one of one or more hops, a time between the one or more hops, a same numerology and bandwidth among the one or more hops, a different numerology and bandwidth among the one or more hops, or a switching time between the one or more hops.

The controller 1206 may manage input and output signals for the UE 1200. The controller 1206 may also manage peripherals not integrated into the UE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the UE 1200 may include at least one transceiver 1208. In some other implementations, the UE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

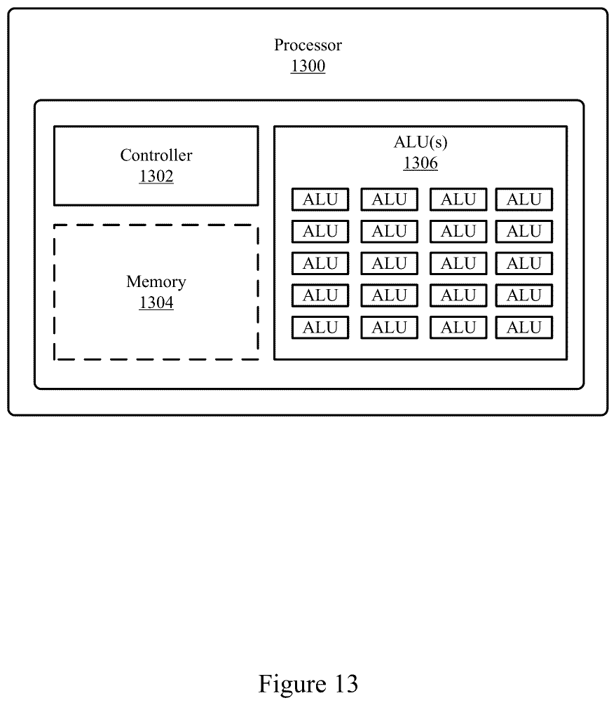

FIG. 13 illustrates an example of a processor 1300 in accordance with aspects of the present disclosure. The processor 1300 may be an example of a processor configured to perform various operations in accordance with examples as described herein. The processor 1300 may include a controller 1302 configured to perform various operations in accordance with examples as described herein. The processor 1300 may optionally include at least one memory 1304, which may be, for example, an L1/L2/L3 cache. Additionally, or alternatively, the processor 1300 may optionally include one or more arithmetic-logic units (ALUs) 1306. One or more of these components may be in electronic communication or otherwise coupled (e.g., operatively, communicatively, functionally, electronically, electrically) via one or more interfaces (e.g., buses).

The processor 1300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1302 may be configured to manage and coordinate various operations (e.g., signaling, receiving, obtaining, retrieving, transmitting, outputting, forwarding, storing, determining, identifying, accessing, writing, reading) of the processor 1300 to cause the processor 1300 to support various operations in accordance with examples as described herein. For example, the controller 1302 may operate as a control unit of the processor 1300, generating control signals that manage the operation of various components of the processor 1300. These control signals include enabling or disabling functional units, selecting data paths, initiating memory access, and coordinating timing of operations.

The controller 1302 may be configured to fetch (e.g., obtain, retrieve, receive) instructions from the memory 1304 and determine subsequent instruction(s) to be executed to cause the processor 1300 to support various operations in accordance with examples as described herein. The controller 1302 may be configured to track memory addresses of instructions associated with the memory 1304. The controller 1302 may be configured to decode instructions to determine the operation to be performed and the operands involved. For example, the controller 1302 may be configured to interpret the instruction and determine control signals to be output to other components of the processor 1300 to cause the processor 1300 to support various operations in accordance with examples as described herein. Additionally, or alternatively, the controller 1302 may be configured to manage flow of data within the processor 1300. The controller 1302 may be configured to control transfer of data between registers, ALUs 1306, and other functional units of the processor 1300.

The memory 1304 may include one or more caches (e.g., memory local to or included in the processor 1300 or other memory, such as RAM, ROM, DRAM, SDRAM, SRAM, MRAM, flash memory, etc. In some implementations, the memory 1304 may reside within or on a processor chipset (e.g., local to the processor 1300). In some other implementations, the memory 1304 may reside external to the processor chipset (e.g., remote to the processor 1300).

The memory 1304 may store computer-readable, computer-executable code including instructions that, when executed by the processor 1300, cause the processor 1300 to perform various functions described herein. The code may be stored in a non-transitory computer-readable medium such as system memory or another type of memory. The controller 1302 and/or the processor 1300 may be configured to execute computer-readable instructions stored in the memory 1304 to cause the processor 1300 to perform various functions. For example, the processor 1300 and/or the controller 1302 may be coupled with or to the memory 1304, the processor 1300, and the controller 1302, and may be configured to perform various functions described herein. In some examples, the processor 1300 may include multiple processors and the memory 1304 may include multiple memories. One or more of the multiple processors may be coupled with one or more of the multiple memories, which may, individually or collectively, be configured to perform various functions herein.

The one or more ALUs 1306 may be configured to support various operations in accordance with examples as described herein. In some implementations, the one or more ALUs 1306 may reside within or on a processor chipset (e.g., the processor 1300). In some other implementations, the one or more ALUs 1306 may reside external to the processor chipset (e.g., the processor 1300). One or more ALUs 1306 may perform one or more computations such as addition, subtraction, multiplication, and division on data. For example, one or more ALUs 1306 may receive input operands and an operation code, which determines an operation to be executed. One or more ALUs 1306 may be configured with a variety of logical and arithmetic circuits, including adders, subtractors, shifters, and logic gates, to process and manipulate the data according to the operation. Additionally, or alternatively, the one or more ALUs 1306 may support logical operations such as AND, OR, exclusive-OR (XOR), not-OR (NOR), and not-AND (NAND), enabling the one or more ALUs 1306 to handle conditional operations, comparisons, and bitwise operations.

The processor 1300 may support wireless communication in accordance with examples as disclosed herein. The processor 1300 may be configured to or operable to support at least one controller coupled with at least one memory and configured to cause the processor to: receive a resource allocation configuration to perform SL-PRS transmission over unlicensed carriers, the resource allocation configuration comprising at least RB sets, subchannel sizes, subchannel numbers, and comb-sizes of multiple SL-PRSs; and transmit at least one SL-PRS over an unlicensed carrier based at least in part on the resource allocation configuration.

Additionally, the processor 1300 may be configured to support any one or combination of the at least one controller is configured to cause the processor to transmit the at least one SL-PRS over one or more unlicensed carriers to multiple communication devices based at least in part on the resource allocation configuration. The at least one controller is configured to cause the processor to transmit the multiple SL-PRSs over one or more unlicensed carriers to multiple communication devices based at least in part on the resource allocation configuration. The at least one controller is configured to cause the processor to transmit a resource allocation configuration request, and in response, receive the resource allocation configuration. The resource allocation configuration is pre-configured by at least one of a UE or a communication device. The UE is at least one of a target UE, an anchor UE with or without a known location, a server UE, a client UE, or a roadside unit. The at least one controller is configured to cause the processor to transmit the at least one SL-PRS over the unlicensed carrier to a communication device, the communication device being at least one of a base station, a location server, a target UE, an anchor UE with or without a known location, a server UE, a client UE, or a roadside-unit. The resource allocation configuration indicates a shared resource pool structure with at least one of RB sets defined for SL-PRS and associated sidelink control information, or the RB sets defined for sidelink data and the associated sidelink control information. The resource allocation configuration indicates a shared resource pool structure with RB sets defined for SL-PRS, sidelink data, and associated sidelink control information. The resource allocation configuration indicates a dedicated resource pool structure with RB sets defined for SL-PRS and associated sidelink control information. The resource allocation configuration comprises at least one of a sidelink BWP, a sidelink positioning resource pool defined in terms of the RB sets, a SL-PRS bandwidth indication, or an indication of contiguous PRB resource allocation or interlaced PRS resource allocation. A sidelink positioning RB set configuration comprises at least one of multiple SL-PRS resource IDs, SL-PRS resource set IDs, SL-PRS transmission-reception point IDs, SL-PRS comb offsets and associated SL-PRS comb sizes, SL-PRS starting symbols and a number of SL-PRS symbols, a number of subchannels, or a channel size. A sidelink positioning RB set configuration comprises multiple interlaced transmissions for SL-PRS RB sets with a number of interlaces that are equally spaced according to a parameter that indicates the number of interlaces or RBs between each of the multiple interlaced RB transmissions. The sidelink positioning RB set configuration is associated with different sidelink positioning transmitters differentiated by IDs comprising at least one of a source-ID, a session-ID, a destination-ID, a unique layer-1 ID, or a unique layer-2 ID. Signaling for the resource allocation configuration includes at least one of a lower-layer UE-specific signaling, a higher-layer UE-specific signaling, or broadcast signaling. Intra-cell guard bands are configured for sidelink data or the SL-PRS transmission. At least one of a transmit frequency hopping for SL-PRS or a receive frequency hopping for SL-PRS is enabled across the RB sets based at least in part on a received frequency hopping configuration comprising one or more sidelink positioning measurements corresponding to at least one of one or more hops, a time between the one or more hops, a same numerology and bandwidth among the one or more hops, a different numerology and bandwidth among the one or more hops, or a switching time between the one or more hops.

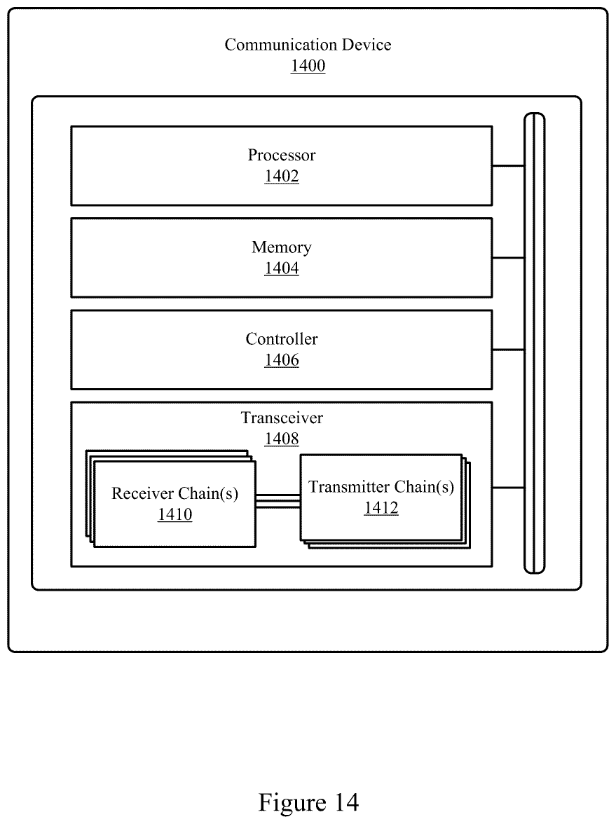

FIG. 14 illustrates an example of a communication device 1400 in accordance with aspects of the present disclosure. The communication device 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1402 may include an intelligent hardware device (e.g., a general-purpose processor, a DSP, a CPU, an ASIC, an FPGA, or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the communication device 1400 to perform various functions of the present disclosure.

The memory 1404 may include volatile or non-volatile memory. The memory 1404 may store computer-readable, computer-executable code including instructions when executed by the processor 1402 cause the communication device 1400 to perform various functions described herein. The code may be stored in a non-transitory computer-readable medium such as the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the communication device 1400 to perform one or more of the functions described herein (e.g., executing, by the processor 1402, instructions stored in the memory 1404). For example, the processor 1402 may support wireless communication at the communication device 1400 in accordance with examples as disclosed herein. The communication device 1400 may be configured to or operable to support a means for receiving, from a second communication device, a resource allocation configuration to perform SL-PRS transmission over unlicensed carriers, the resource allocation configuration comprising at least RB sets, subchannel sizes, subchannel numbers, and comb-sizes of multiple SL-PRSs; and transmitting at least one SL-PRS to the second communication device over an unlicensed carrier based at least in part on the resource allocation configuration.

Additionally, the communication device 1400 may be configured to support any one or combination of the method further comprising transmitting the at least one SL-PRS over one or more unlicensed carriers to multiple communication devices based at least in part on the resource allocation configuration. The method further comprising transmitting multiple SL-PRSs over one or more unlicensed carriers to multiple communication devices based at least in part on the resource allocation configuration. The method further comprising transmitting a resource allocation configuration request, and in response, receiving the resource allocation configuration. The resource allocation configuration is pre-configured by at least one of the first communication device or the second communication device. The first communication device is at least one of a target UE, an anchor UE with or without a known location, a server UE, a client UE, or a roadside unit. The second communication device is at least one of a base station, a location server, a target UE, an anchor UE with or without a known location, a server UE, a client UE, or a roadside-unit. The resource allocation configuration indicates a shared resource pool structure with at least one of RB sets defined for SL-PRS and associated sidelink control information, or the RB sets defined for sidelink data and the associated sidelink control information. The resource allocation configuration indicates a shared resource pool structure with RB sets defined for SL-PRS, sidelink data, and associated sidelink control information. The resource allocation configuration indicates a dedicated resource pool structure with RB sets defined for SL-PRS and associated sidelink control information. The resource allocation configuration comprises at least one of a sidelink BWP, a sidelink positioning resource pool defined in terms of the RB sets, a SL-PRS bandwidth indication, or an indication of contiguous PRB resource allocation or interlaced PRS resource allocation. A sidelink positioning RB set configuration comprises at least one of multiple SL-PRS resource IDs, SL-PRS resource set IDs, SL-PRS transmission-reception point IDs, SL-PRS comb offsets and associated SL-PRS comb sizes, SL-PRS starting symbols and a number of SL-PRS symbols, a number of subchannels, or a channel size. A sidelink positioning RB set configuration comprises multiple interlaced transmissions for SL-PRS RB sets with a number of interlaces that are equally spaced according to a parameter that indicates the number of interlaces or RBs between each of the multiple interlaced RB transmissions. The sidelink positioning RB set configuration is associated with different sidelink positioning transmitters differentiated by IDs comprising at least one of a source-ID, a session-ID, a destination-ID, a unique layer-1 ID, or a unique layer-2 ID. Signaling for the resource allocation configuration includes at least one of a lower-layer UE-specific signaling, a higher-layer UE-specific signaling, or broadcast signaling. Intra-cell guard bands are configured for sidelink data or the SL-PRS transmission. At least one of a transmit frequency hopping for SL-PRS or a receive frequency hopping for SL-PRS is enabled across the RB sets based at least in part on a received frequency hopping configuration comprising one or more sidelink positioning measurements corresponding to at least one of one or more hops, a time between the one or more hops, a same numerology and bandwidth among the one or more hops, a different numerology and bandwidth among the one or more hops, or a switching time between the one or more hops.

Additionally, or alternatively, the communication device 1400 may support at least one memory and at least one processor coupled with the at least one memory and configured to cause the first communication device to: receive, from a second communication device, a resource allocation configuration to perform SL-PRS transmission over unlicensed carriers, the resource allocation configuration comprising at least RB sets, subchannel sizes, subchannel numbers, and comb-sizes of multiple SL-PRSs; and transmit at least one SL-PRS to the second communication device over an unlicensed carrier based at least in part on the resource allocation configuration.

Additionally, the communication device 1400 may be configured to support any one or combination of the at least one processor is configured to cause the first communication device to transmit the at least one SL-PRS over one or more unlicensed carriers to multiple communication devices based at least in part on the resource allocation configuration. The at least one processor is configured to cause the first communication device to transmit the multiple SL-PRSs over one or more unlicensed carriers to multiple communication devices based at least in part on the resource allocation configuration. The at least one processor is configured to cause the first communication device to transmit a resource allocation configuration request, and in response, receive the resource allocation configuration. The resource allocation configuration is pre-configured by at least one of the first communication device or the second communication device. The first communication device is at least one of a target UE, an anchor UE with or without a known location, a server UE, a client UE, or a roadside unit. The second communication device is at least one of a base station, a location server, a target UE, an anchor UE with or without a known location, a server UE, a client UE, or a roadside-unit. The resource allocation configuration indicates a shared resource pool structure with at least one of RB sets defined for SL-PRS and associated sidelink control information, or the RB sets defined for sidelink data and the associated sidelink control information. The resource allocation configuration indicates a shared resource pool structure with RB sets defined for SL-PRS, sidelink data, and associated sidelink control information. The resource allocation configuration indicates a dedicated resource pool structure with RB sets defined for SL-PRS and associated sidelink control information. The resource allocation configuration comprises at least one of a sidelink BWP, a sidelink positioning resource pool defined in terms of the RB sets, a SL-PRS bandwidth indication, or an indication of contiguous PRB resource allocation or interlaced PRS resource allocation. A sidelink positioning RB set configuration comprises at least one of multiple SL-PRS resource IDs, SL-PRS resource set IDs, SL-PRS transmission-reception point IDs, SL-PRS comb offsets and associated SL-PRS comb sizes, SL-PRS starting symbols and a number of SL-PRS symbols, a number of subchannels, or a channel size. A sidelink positioning RB set configuration comprises multiple interlaced transmissions for SL-PRS RB sets with a number of interlaces that are equally spaced according to a parameter that indicates the number of interlaces or RBs between each of the multiple interlaced RB transmissions. The sidelink positioning RB set configuration is associated with different sidelink positioning transmitters differentiated by IDs comprising at least one of a source-ID, a session-ID, a destination-ID, a unique layer-1 ID, or a unique layer-2 ID. Signaling for the resource allocation configuration includes at least one of a lower-layer UE-specific signaling, a higher-layer UE-specific signaling, or broadcast signaling. Intra-cell guard bands are configured for sidelink data or the SL-PRS transmission. At least one of a transmit frequency hopping for SL-PRS or a receive frequency hopping for SL-PRS is enabled across the RB sets based at least in part on a received frequency hopping configuration comprising one or more sidelink positioning measurements corresponding to at least one of one or more hops, a time between the one or more hops, a same numerology and bandwidth among the one or more hops, a different numerology and bandwidth among the one or more hops, or a switching time between the one or more hops.

The controller 1406 may manage input and output signals for the communication device 1400. The controller 1406 may also manage peripherals not integrated into the communication device 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the communication device 1400 may include at least one transceiver 1408. In some other implementations, the communication device 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas to receive a signal over the air or wireless medium. The receiver chain 1410 may include at least one amplifier (e.g., a low-noise amplifier (LNA)) configured to amplify the received signal. The receiver chain 1410 may include at least one demodulator configured to demodulate the receive signal and obtain the transmitted data by reversing the modulation technique applied during transmission of the signal. The receiver chain 1410 may include at least one decoder for decoding the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

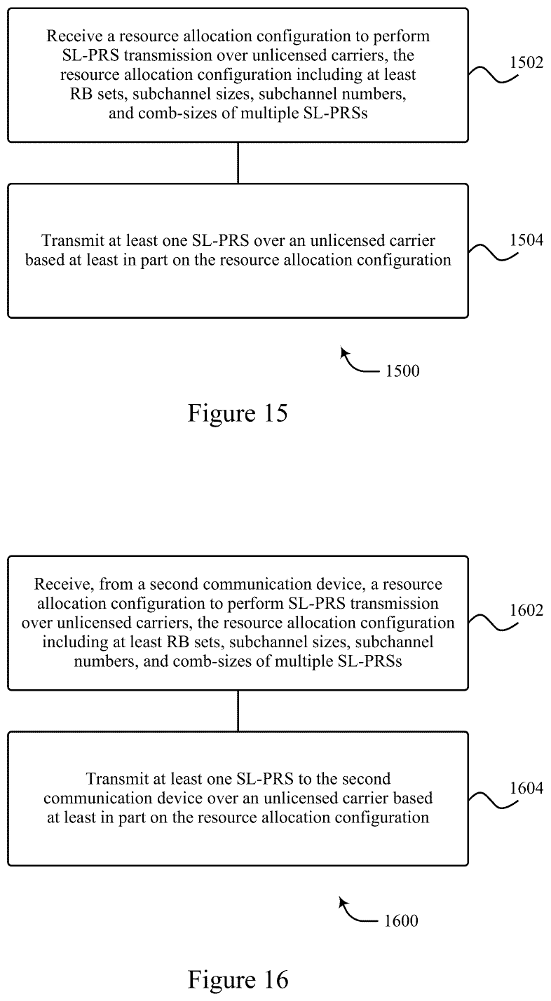

FIG. 15 illustrates a flowchart of a method 1500 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1502, the method may include receiving a resource allocation configuration to perform SL-PRS transmission over unlicensed carriers, the resource allocation configuration including at least RB sets, subchannel sizes, subchannel numbers, and comb-sizes of multiple SL-PRSs. The operations of 1502 may be performed in accordance with examples as described herein. In some implementations, aspects of the operations of 1502 may be performed by a UE as described with reference to FIG. 12.

At 1504, the method may include transmitting at least one SL-PRS over an unlicensed carrier based at least in part on the resource allocation configuration. The operations of 1504 may be performed in accordance with examples as described herein. In some implementations, aspects of the operations of 1504 may be performed by a UE as described with reference to FIG. 12.

FIG. 16 illustrates a flowchart of a method 1600 in accordance with aspects of the present disclosure. The operations of the method may be implemented by a communication device as described herein. In some implementations, the communication device may execute a set of instructions to control the function elements of the communication device to perform the described functions. It should be noted that the method described herein describes a possible implementation, and that the operations and the steps may be rearranged or otherwise modified and that other implementations are possible.

At 1602, the method may include receiving, from a second communication device, a resource allocation configuration to perform SL-PRS transmission over unlicensed carriers, the resource allocation configuration including at least RB sets, subchannel sizes, subchannel numbers, and comb-sizes of multiple SL-PRSs. The operations of 1602 may be performed in accordance with examples as described herein. In some implementations, aspects of the operations of 1602 may be performed by a communication device as described with reference to FIG. 14.

At 1604, the method may include transmitting at least one SL-PRS to the second communication device over an unlicensed carrier based at least in part on the resource allocation configuration. The operations of 1604 may be performed in accordance with examples as described herein. In some implementations, aspects of the operations of 1604 may be performed by a communication device as described with reference to FIG. 14.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a resource allocation configuration to perform sidelink positioning reference signal (SL-PRS) transmission over unlicensed carriers, the resource allocation configuration comprising at least resource block (RB) sets, subchannel sizes, subchannel numbers, and comb-sizes of multiple SL-PRSs; and
transmit at least one SL-PRS over an unlicensed carrier based at least in part on the resource allocation configuration.

2. The UE of claim 1, wherein the at least one processor is configured to cause the UE to transmit the at least one SL-PRS over one or more unlicensed carriers to multiple communication devices based at least in part on the resource allocation configuration.

3. The UE of claim 1, wherein the at least one processor is configured to cause the UE to transmit the multiple SL-PRSs over one or more unlicensed carriers to multiple communication devices based at least in part on the resource allocation configuration.

4. The UE of claim 1, wherein the at least one processor is configured to cause the UE to transmit a resource allocation configuration request, and in response, receive the resource allocation configuration.

5. The UE of claim 1, wherein the resource allocation configuration is pre-configured by at least one of the UE or a communication device.

6. The UE of claim 1, wherein the UE is at least one of a target UE, an anchor UE with or without a known location, a server UE, a client UE, or a roadside unit.

7. The UE of claim 1, wherein the at least one processor is configured to cause the UE to transmit the at least one SL-PRS over the unlicensed carrier to a communication device, the communication device being at least one of a base station, a location server, a target UE, an anchor UE with or without a known location, a server UE, a client UE, or a roadside-unit.

8. The UE of claim 1, wherein the resource allocation configuration indicates a shared resource pool structure with at least one of RB sets defined for SL-PRS and associated sidelink control information, or the RB sets defined for sidelink data and the associated sidelink control information.

9. The UE of claim 1, wherein the resource allocation configuration indicates a shared resource pool structure with RB sets defined for SL-PRS, sidelink data, and associated sidelink control information.

10. The UE of claim 1, wherein the resource allocation configuration indicates a dedicated resource pool structure with RB sets defined for SL-PRS and associated sidelink control information.

11. The UE of claim 1, wherein the resource allocation configuration comprises at least one of a sidelink bandwidth part (BWP), a sidelink positioning resource pool defined in terms of the RB sets, a SL-PRS bandwidth indication, or an indication of contiguous physical resource block (PRB) resource allocation or interlaced PRS resource allocation.

12. The UE of claim 1, wherein a sidelink positioning RB set configuration comprises multiple interlaced transmissions for SL-PRS RB sets with a number of interlaces that are equally spaced according to a parameter that indicates the number of interlaces or RBs between each of the multiple interlaced RB transmissions.

13. A processor for wireless communication, comprising:
at least one controller coupled with at least one memory and configured to cause the processor to:
receive a resource allocation configuration to perform sidelink positioning reference signal (SL-PRS) transmission over unlicensed carriers, the resource allocation configuration comprising at least resource block (RB) sets, subchannel sizes, subchannel numbers, and comb-sizes of multiple SL-PRSs; and
transmit at least one SL-PRS over an unlicensed carrier based at least in part on the resource allocation configuration.

14. The processor of claim 13, wherein the at least one controller is configured to cause the processor to transmit the at least one SL-PRS over one or more unlicensed carriers to multiple communication devices based at least in part on the resource allocation configuration.

15. The processor of claim 13, wherein the at least one controller is configured to cause the processor to transmit the multiple SL-PRSs over one or more unlicensed carriers to multiple communication devices based at least in part on the resource allocation configuration.

16. The processor of claim 13, wherein the at least one controller is configured to cause the processor to transmit a resource allocation configuration request, and in response, receive the resource allocation configuration.

17. The processor of claim 13, wherein the resource allocation configuration is pre-configured by at least one of a user equipment (UE) or a communication device.

18. The processor of claim 13, wherein the resource allocation configuration indicates a shared resource pool structure with at least one of RB sets defined for SL-PRS and associated sidelink control information, or the RB sets defined for sidelink data and the associated sidelink control information.

19. A method performed by a user equipment (UE), the method comprising:
receiving a resource allocation configuration to perform sidelink positioning reference signal (SL-PRS) transmission over unlicensed carriers, the resource allocation configuration comprising at least resource block (RB) sets, subchannel sizes, subchannel numbers, and comb-sizes of multiple SL-PRSs; and
transmitting at least one SL-PRS over an unlicensed carrier based at least in part on the resource allocation configuration.

20. A first communication device for wireless communication, comprising:
at least one memory; and
at least one processor coupled with the at least one memory and configured to cause the first communication device to:
receive, from a second communication device, a resource allocation configuration to perform sidelink positioning reference signal (SL-PRS) transmission over unlicensed carriers, the resource allocation configuration comprising at least resource block (RB) sets, subchannel sizes, subchannel numbers, and comb-sizes of multiple SL-PRSs; and
transmit at least one SL-PRS to the second communication device over an unlicensed carrier based at least in part on the resource allocation configuration.
